(19) United States
(12) Patent Application Publication
(10) Pub. No.: US 2023/0418848 A1
(43) Pub. Date: Dec. 28, 2023

(54) NEURAL RANKING MODEL FOR GENERATING SPARSE REPRESENTATIONS FOR INFORMATION RETRIEVAL

(71) Applicant: NAVER CORPORATION, Seongnam-si (KR)

(72) Inventors: Stéphane CLINCHANT, Meylan (FR); Carlos LASSANCE, Grenoble (FR)

(21) Appl. No.: 18/312,703

(22) Filed: May 5, 2023

Related U.S. Application Data
(60) Provisional application No. 63/367,092, filed on Jun. 27, 2022.

(51) Int. Cl. G06F 16/332; G06F 40/40; G06F 40/284

(52) U.S. Cl. CPC G06F 16/332; G06F 40/40; G06F 40/284

(57) ABSTRACT

A ranker for a neural information retrieval model comprises a document encoder having a pretrained language model layer and configured to receive one or more documents and generate a sparse representation for each of the documents predicting term importance of the document over a vocabulary. A separate query encoder is configured to receive a query and generate a representation of the query over the vocabulary. Generated representations are compared to generate a set of respective document scores and rank the one or more documents.

### REFERENCE TO RELATED APPLICATIONS

This application claims priority to and benefit from U.S. Provisional patent application Ser. No. 63/367,092, filed Jun. 27, 2022, which application is incorporated in its entirety by reference herein.

This application is related in subject matter to U.S. patent application Ser. No. 17/804,983, filed Jun. 1, 2022, and entitled NEURAL RANKING MODEL FOR GENERATING SPARSE REPRESENTATIONS FOR INFORMATION RETRIEVAL, which application is incorporated in its entirety by reference herein.

### FIELD

The present disclosure relates generally to machine learning, and more particularly to neural language models such as ranking models for information retrieval.

### BACKGROUND

For neural information retrieval (IR), it is useful to improve first-stage retrievers in ranking pipelines. For instance, bag-of-words (BOVV) models suffer from the longstanding vocabulary mismatch problem, in which relevant documents might not contain terms that appear in the query. Thus, there have been efforts to instead use learned (neural) rankers.

Pretrained language models (LMs) such as those based on Bidirectional Encoder Representations from Transformers (BERT) models are increasingly popular for natural language processing (NLP) and for re-ranking tasks in information retrieval. LM-based neural models have shown a strong ability to adapt to various tasks by simple fine-tuning.

LM-based ranking models can provide improved results for passage re-ranking tasks. However, such models introduce challenges of efficiency and scalability. Because of practical efficiency requirements, LM-based models conventionally have been used only as re-rankers in a two-stage ranking pipeline, while a first stage retrieval (or candidate generation) is conducted with BOW models that rely on inverted indexes or term-based approaches such as BM25 for first-stage ranking.

It is useful to provide IR methods in which most of the involved computation can be done offline and where online inference is fast. Learning dense embeddings to conduct retrieval using efficient approximate nearest neighbors (ANN) methods has shown good results, but such methods are still combined with BOW models (e.g., combining both types of signals) due to their inability to explicitly model term matching.

There has been a growing interest in learning sparse representations for queries and documents. Using sparse representations, models can inherit desirable properties from BOW models such as exact match of (possibly latent) terms, efficiency of inverted indexes, and interpretability. Additionally, by modeling implicit or explicit (latent, contextualized) expansion mechanisms, similarly to standard expansion models in IR, models can reduce vocabulary mismatch.

Dense retrieval based on BERT Siamese models is a standard approach for candidate generation in question answering and information retrieval tasks. An alternative to dense indexes is term-based ones. For instance, building on standard BOW models, Zamani et al. disclosed SNRM (in “From Neural Re-Ranking to Neural Ranking: Learning a Sparse Representation of Inverted Indexing”, and published in Proceedings of the 27th ACM International Conference on Information and Knowledge Management (Torino, Italy) (CIKM '18), Association for Computing Machinery, New York, NY, USA, pp. 497-506, 2018), in which a model embeds documents and queries in a sparse high-dimensional latent space using L1 regularization on representations. However, SNRM's effectiveness has remained limited.

More recently, there have been attempts to transfer knowledge from pretrained LMs to sparse approaches. For example, based on BERT, DeepCT (Dai and Callan, 2019, Context-Aware Sentence/Passage Term Importance Estimation For First Stage Retrieval, arXiv:1910.10687 [cs.IR]) focuses on learning contextualized term weights in the full vocabulary space, akin to BOW term weights. However, as the vocabulary associated with a document remains the same, this type of approach does not address vocabulary mismatch, as acknowledged by the use of query expansion for retrieval.

Another approach is to expand documents using generative methods to predict expansion words for documents. Document expansion adds new terms to documents, thus fighting the vocabulary mismatch, and repeats existing terms, implicitly performing reweighting by boosting important terms. Methods, though, are limited by the way in which they are trained (predicting queries), which is indirect in nature and limits their progress.

Still another approach is to estimate the importance of each term of the vocabulary implied by each term of the document; that is, to compute an interaction matrix between the document or query tokens and all the tokens from the vocabulary. This can be followed by an aggregation mechanism that allows for the computation of an importance weight for each term of the vocabulary, for the full document or query.

However, current methods either provide representations that are not sparse enough to provide fast retrieval, and/or they exhibit suboptimal performance.

### SUMMARY

Provided herein, among other things, is a computer-implemented ranker for a neural information retrieval model. The ranker comprises a document encoder having a pretrained language model layer and configured to receive one or more documents and generate a sparse representation for each of the documents predicting term importance of the document over a vocabulary. A separate query encoder is configured to receive a query and generate a representation of the query over the vocabulary. Generated representations are compared to generate a set of respective document scores and rank the one or more documents.

According to a complementary aspect, the present disclosure provides a computer program product, comprising code instructions to execute a method according to the previously described aspects; and a computer-readable medium, on which is stored a computer program product comprising code instructions for executing a method according to the previously described embodiments and aspects. The present disclosure further provides a processor configured using code instructions for executing a method according to the previously described embodiments and aspects.

Other features and advantages of the invention will be apparent from the following specification taken in conjunction with the following drawings.

### DESCRIPTION OF THE DRAWINGS

The accompanying drawings are incorporated into the specification for the purpose of explaining the principles of the embodiments. The drawings are not to be construed as limiting the invention to only the illustrated and described embodiments or to how they can be made and used. Further features and advantages will become apparent from the following and, more particularly, from the description of the embodiments as illustrated in the accompanying drawings, wherein:

FIG. 1 shows an example processor-based system for information retrieval (IR) of documents.

FIG. 2 shows an example processor-based method for encoding a sequence to provide a sparse representation.

FIG. 3 shows an example neural encoder for performing the method of FIG. 2.

FIG. 4 shows an example process for comparing documents and queries using an efficiency-enhanced neural ranking model.

FIG. 5 shows an example training method for a neural ranking model including regularization.

FIG. 6 shows an example middle training method for a neural ranking model.

FIG. 7 shows a comparison of efficiency and performance results for several example pretrained LM-based neural ranking models, where each example model cumulatively modifies a model (SPLADEv2-distill) with efficiency enhancements.

FIG. 8 shows a comparison of efficiency and performance results for example pretrained LM-based neural ranking models modifying SPLADEv2-distill with efficiency enhancements I)-V) and I)-(VI), respectively, and further compared to state-of-the-art neural ranking models.

FIG. 9 shows an example architecture in which example methods can be implemented.

In the drawings, reference numbers may be reused to identify similar and/or identical elements.

### DETAILED DESCRIPTION

It is desirable to provide neural ranker models (rankers) for document ranking in information retrieval (IR) by generating (vector) representations that are sparse enough to allow the use of inverted indexes for retrieval (which is faster and more reliable than methods such as approximate nearest neighbor (ANN) methods, and enables exact matching), while performing comparably to neural IR representations using dense embedding.

Example neural ranker models can combine rich term embeddings such as can be provided by pretrained language models (LMs) such as Bidirectional Encoder Representations from Transformers (BERT)-based LMs, where documents are represented by tokens in a particular vocabulary space. Such models can provide sparsity that allows efficient matching algorithms for IR based on inverted indexes.

Example rankers include one or more encoders that encode an input sequence, such as a document or query, to provide sparse representations (sparse vector representations or sparse lexical expansions; i.e., where a subset of parameters may represent a larger set of parameters; e.g., where a subset of parameters are the only non-zero parameters that form part of a larger set of parameters of a model represented using a high-dimensional vector space; a sparse matrix is a matrix in which most elements are zero) in the context of IR by predicting a term importance of the input sequence over a vocabulary. Such systems and methods can provide, among other things, expansion-aware representations of documents and queries.

As will be explained in more detail herein, efficiency of rankers can be further enhanced by providing separate encoders for documents and queries, respectively. The separate document and query encoders may be differentiated based on, for instance, their respective architecture, size, model weights, training, regularization, hyperparameters, location, etc. In some embodiments, the ranker may include a query encoder that is smaller (and/or faster) than a document encoder. In other embodiments, a document encoder based on a pre-trained LM may be provided in a ranker for document encoding, while a query encoder based on a pre-trained LM may be omitted from or otherwise not used in the ranker for encoding queries (e.g., only a document encoder based on a pre-trained LM is provided, or only a document encoder is provided at all).

An example encoder includes a pretrained LM, trained using a self-supervised pretraining objective, to determine a prediction of an importance (or weight) for the input sequence over the vocabulary (term importance) with respect to tokens of the input sequence. A representation providing the predicted importance of the input sequence over the vocabulary can be obtained by performing an activation that includes a concave function to prevent some terms from dominating. Example concave activation functions can provide a log-saturation effect, while others can use functions such as radical functions (e.g., sqrt (1+x)).

Neural ranker models can be further trained using regularization. Regularization may allow for end-to-end, single-stage training, without relying on handcrafted sparsification strategies such as BOW masking. Concave activation functions combined with regularization can provide highly sparse representations.

For instance, sparsity regularization can ensure sparsity of the produced representations and improve both the efficiency (computational speed; e.g., the number of queries the ranker (or retriever) model is able to process in a given time, or equivalently the amount of time taken by the model to process a query (latency)) and the effectiveness (quality of lexical expansions) of first-stage ranking models. Using sparsity regularization, example models may also be trained end-to-end in a single stage, though this is not required.

In some example encoders, this regularization may consider an expected number of floating-point operations (FLOPS). The contribution of the sparsity regularization can be controlled using weights (a regularization factor) to influence the trade-off between effectiveness and efficiency.

In other example encoders, regularization may be based on other criteria. For instance, in some example rankers, a query encoder may be regularized based on an L1 loss, while the document encoder, on the other hand, may be regularized using FLOPS regularization.

Efficiency enhancements as well as performance enhancements may also be incorporated during training of the document encoder, the query encoder, and/or the neural ranker. For instance, by searching for appropriate hyperparameters, improving data used for training, or a combination, retrieval efficiency can be improved.

Neural ranking models may be trained using in-batch negative sampling, in which some negative documents are included from other queries to provide a ranking loss that can be combined with sparsity regularization in an overall loss. Training using in-batch negative sampling can further improve the performance of example models. Neural ranking models may also be trained using distillation to provide more accurate evaluations of query-document pairs.

To further improve retrieval efficiency, a middle training step may be performed on pretrained LM-based encoders between pretraining and fine-tuning. Alternatively, a middle training step may be performed concurrently with pretraining and before fine-tuning. The middle training improves a state of the ranker for fine-tuning. An example middle training step may include training the pretrained LM using a masked language model (MLM) loss (such as but not limited to the MLM loss used for pretraining) combined with a FLOPS regularization step. In other embodiments, the middle training step can be combined with a pretraining step for the LM.

Example efficiency enhancements can be used individually or in one or more combinations (where practicable) to improve efficiency, or cumulatively to provide further efficiency enhancements. Enhancing efficiency using example techniques can in many instances also improve effectiveness. For further improvement of retrieval effectiveness with out-of-domain data with a relatively small impact on retrieval latency, example rankers can also be merged with other, e.g., faster document scoring models. Experiments disclosed herein demonstrated that efficiency-enhanced neural ranking models, e.g., used for a first-stage ranker for information retrieval, can provide retrieval efficiency comparable to existing sparse retrieval methods, as well as comparable effectiveness, or even improved effectiveness, compared to state-of-the-art dense retrieval methods, both in-domain and out-of-domain.

Information Retrieval Model

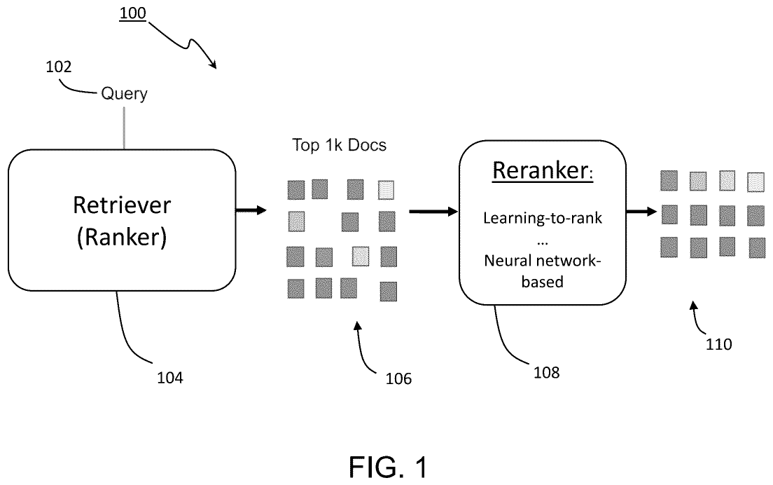

Referring now to the drawings, FIG. 1 shows an example system 100 using a neural model for information retrieval (IR) of documents, such as but not limited to a search engine. A query 102 is input to a first-stage retriever (ranker) 104. Example queries include but are not limited to search requests or search terms for providing one or more documents (of any format), questions to be answered, items to be identified, etc. The first-stage retriever or ranker 104 processes the query 102 to provide a ranking of available documents, and retrieves a first set 106 of top-ranked documents. A second-stage or reranker 108 then reranks the retrieved set 106 of top-ranked documents and outputs a ranked set 110 of documents, which may be fewer in number than the first set 106.

Example neural ranker models according to embodiments herein may be used for providing rankings for the first-stage retriever or ranker 104, as shown in FIG. 1, in combination with a second-stage reranker 108. Example second-stage rerankers 108 include but are not limited to rerankers implementing learning-to-rank methods such as LambdaMart, RankNET, or GBDT on handcrafted features, or rerankers implementing neural network models with word embedding (e.g., word2vec). Neural network-based rerankers can be representation based, such as DSSM, or interaction based, such as DRMM, K-NRM, or DUET. In other example embodiments, example neural ranker models herein can alternatively or additionally provide rankings for the second stage reranker 108. In other embodiments, example neural ranker models can be used as a standalone ranking and possibly retrieval stage.

Example neural ranker models, whether used in the first-stage 104, the second stage 108, or as a standalone model, may provide representations, e.g., vector representations, of an input sequence over a vocabulary. The vocabulary may be predetermined. The input sequence can be embodied in, for instance, a query sequence such as the query 102, a document sequence to be ranked and/or retrieved based on a query, or any other input sequence. “Document” as used herein broadly refers to any sequence of tokens that can be represented in vector space and ranked using example methods and/or can be retrieved. A query broadly refers to any sequence of tokens that can be represented in vector space for use in ranking and retrieving one or more documents.

Encoding Method Using Pretrained LM-Based Encoders

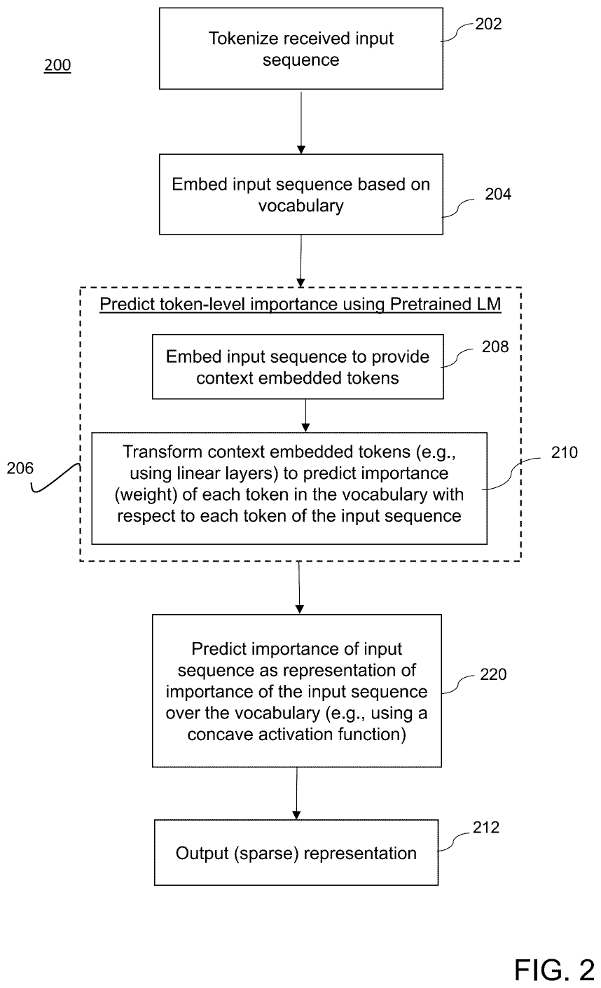

FIG. 2 shows an example encoding method 200 employing a pretrained language model (LM). The encoding method 200 encodes an input sequence by providing a representation of the input sequence over a vocabulary. The vocabulary may be predetermined. A nonlimiting example vocabulary that may be used is BERT WordPiece vocabulary (└V┘=30522), which representation may be used for ranking and/or reranking in IR.

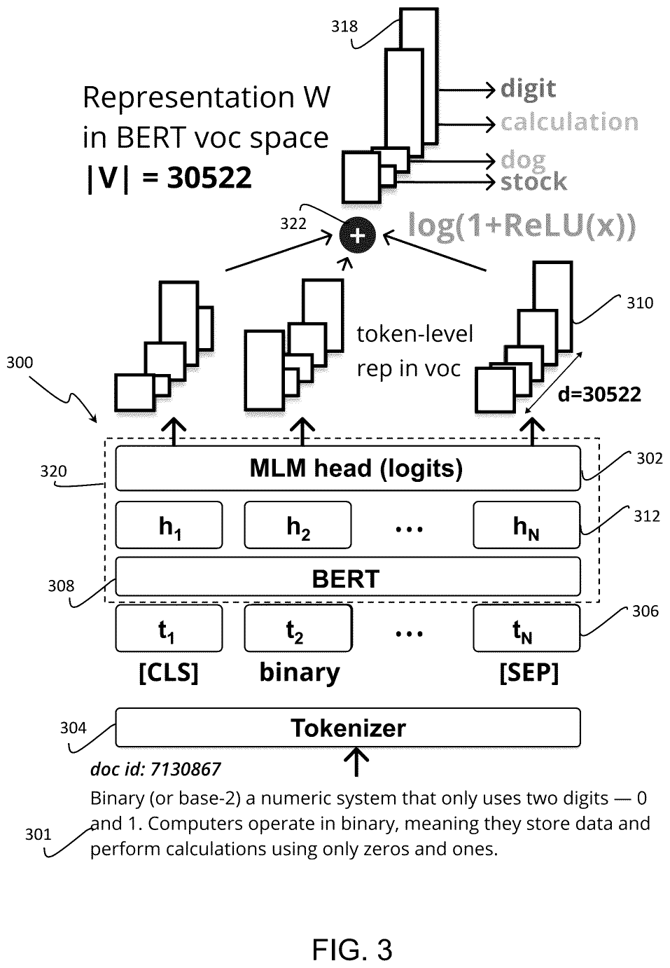

FIG. 3 shows an example encoder 300 of a neural ranker model, such as ranker 104, for performing the encoding method 200. The encoder 300 can be implemented by one or more computers having at least one processor and one memory. For instance, the encoder 300 may be implemented using one or more CPU cores, alone or in combination with one or more GPUs, along with a suitable memory.

The example encoder 300 can infer sparse representations for input sequences, e.g., queries or documents, directly by providing query and/or document expansion. Example encoders 300 can perform expansion using a pretrained language model (LM), such as but not limited to an LM trained using unsupervised methods such as Masked Language Model (MLM) training methods. For instance, the encoder 300 can perform expansion based on the logits (i.e., unnormalized outputs) 302 of a Masked Language Model (MLM)-trained LM 320. Regularization may be used to train example retrievers to ensure or encourage sparsity, as described in more detail herein.

An example pretrained LM may be based on BERT. BERT, e.g., as disclosed in Devlin et al, 2019, BERT: Pre-training of Deep Bidirectional Transformers for Language Understanding, CoRR abs/1810.04805, incorporated herein by reference, is a family of transformer-based training methods and associated models, which may be pre-trained on two tasks: masked-token prediction, referred to as a “masked language model” (MLM) task”; and next-sentence prediction. These models are bidirectional in that each token attends to both its left and right neighbors, not only to its predecessors. Example encoders 300 can exploit pretrained LMs such as those provided by BERT-based models to project token-level importance over a vocabulary (such as over a BERT vocabulary space, or other vocabulary space) for an input sequence, and then obtain predicted importance of the input sequence over the vocabulary to provide a representation of the input sequence. An example transformer architecture is disclosed in U.S. Pat. No. 10,452,978, issued Oct. 22, 2019, which is incorporated in its entirety by reference herein.

The input sequence 301 received by the encoder 300 is tokenized at 202 by a tokenizer layer 304 using the vocabulary (in this example, a predetermined BERT vocabulary) to provide a tokenized input sequence t₁ . . . t_{N} 306. The tokenized input sequence 306 may also include one or more special tokens, such as but not limited to <CLS> (a symbol added in front of an input sequence, which may be used in some BERT methods for classification) and/or <SEP> (used in some BERT methods for a separator), as can be used in BERT embeddings.

Token-level importance or local importance is predicted at 206 using the pretrained LM 320. Token-level or local importance refers to an importance (or weight, or representation) of each token in the vocabulary with respect to each token of the input sequence.

Each token of the tokenized input sequence 306 may be embedded at 208 to provide a sequence of context-embedded tokens h₁ . . . h_{N} 312. This context embedding may be based on, for instance, the vocabulary and the token's position within the input sequence. The context embedded tokens h₁ . . . h_{N} 312 may represent contextual features of the tokens within the embedded input sequence. An example context embedding 208 may use one or more embedding layers of the pretrained LM 320, e.g., one or more transformer-based layers such as BERT layers 308.

Token-level or local importance of the input sequence can be predicted over the vocabulary (e.g., BERT vocabulary space) at 210 from the context-embedded tokens 312. A token-level importance distribution layer, e.g., embodied in a head (logits) 302 of the pretrained LM 320 may be used to predict an importance (or weight) of each token of the vocabulary with respect to each token of the input sequence of tokens; that is, a (input sequence) token-level or local representation 310 in the vocabulary space. For instance, for a pretrained LM trained using MLM methods, the MLM head 302 may transform the context embedded tokens 312 using one or more linear layers, each including at least one logit function, to predict an importance (e.g., weight, or other representation) of each token in the vocabulary with respect to each token of the embedded input sequence and provide the token-level representation 310 in the vocabulary space.

For example, consider an input query or document sequence after tokenization 202 (e.g., WordPiece tokenization) t=t₁, t₂, t . . . t_{N}), and its corresponding BERT embeddings (or BERT-like model embeddings) after context embedding 208 (h₁, h₂, . . . h_{N}). The importance wᵢⱼ of the token j (vocabulary) for a token i (of the input sequence) can be provided at step 210 by:

wᵢⱼ=transform(hᵢ)^{T}Eⱼ+bⱼ j∈{1, . . . └V┘} (1)

where Eⱼ denotes the BERT (or BERT-like model) input embedding resulting from the tokenizer and the model parameter for token j (i.e., a vector representing token j without taking into account the context), bⱼ is a token-level bias, and transform(.) is a linear layer with Gaussian error linear unit (GeLU) activation, e.g., as disclosed in Hendrycks and Gimpel, arXiv:1606.08415, 2016, and a normalization layer LayerNorm. GeLU can be provided, for instance, by x [symbol] xΦ(x), or can be approximated in terms of the tanh(.) function (e.g., as the variance of the Gaussian goes to zero one arrives at a rectified linear unit (ReLU), but for unit variance one gets GeLU). T can correspond to the transpose operation in linear algebra, e.g., to indicate that in the end it is a dot product and may be included in the transform function.

Equation (1) can be equivalent to the MLM prediction. Thus, it can also be initialized, for instance, from a pretrained MLM model (or other pretrained LM).

The encoder 300 then predicts at 220 term importance of the input sequence 318 (e.g., a global term importance for the input sequence) as a representation of importance (e.g., weight) of the input sequence over the vocabulary by performing an activation using a representation layer 322. The representation layer 322 performs a concave activation function over the embedded input sequence. The predicted term importance of the input sequence predicted at 220 may be independent of the length of the input sequence. The concave activation function can be, as nonlimiting examples, a logarithmic activation function or a radical function (e.g., a sqrt (1+x) function; a mapping w→({square root over (1+ReLU(w))−1)})^{k} for an appropriate scaling k, etc.).

For example, a final representation of importance 318 of the input sequence 301 over the vocabulary can be obtained by the encoder 300 by combining (or maximizing, for example) importance predictors over the input sequence tokens, and applying a concave function such as a logarithmic function after applying an activation function such as ReLU to ensure the positivity of term weights:

$${w}_{j} = {max}_{i ∈ t} log ( 1 + ReLU ( {w}_{ij} ) ) \qquad ( 2 )$$

The above example model provides a log-saturation effect that prevents some terms from dominating and (naturally) ensures sparsity in representations. Logarithmic activation has been used, for instance, in computer vision, e.g., as disclosed in Yang Liu et al., Natural-Logarithm-Rectified Activation Function in Convolutional Neural Networks, arXiv, 2019, 1908.03682. While using a log-saturation or other concave functions prevents some terms from dominating, surprisingly the implied sparsity obtains improved results and allows obtaining of sparse solutions without regularization.

The final representation 318 (i.e., the predicted term importance of the input sequence) from the encoder 300 may be output at 212. This representation may be compared to representations from other sequences, including queries or documents, or, since the representations are in the vocabulary space, simply to tokenizations of sequences (e.g., a tokenization of a query over the vocabulary can provide a representation).

Document Scoring for Information Retrieval

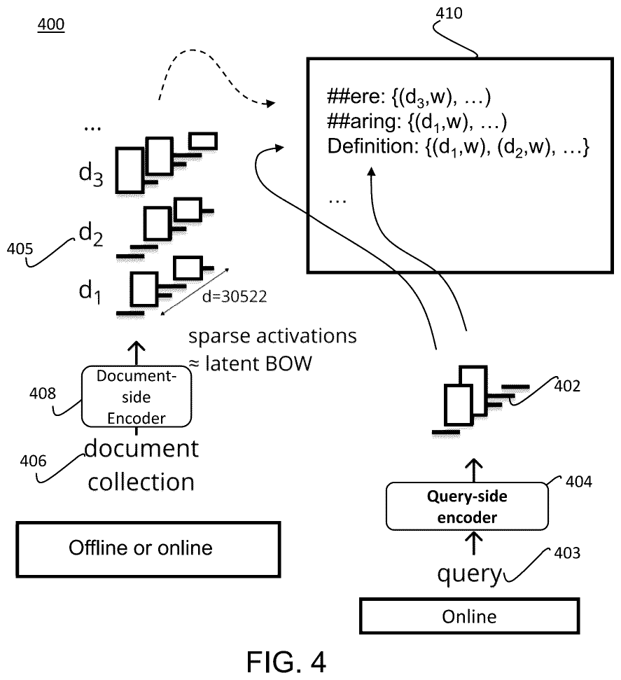

FIG. 4 shows an example comparison method 400 that may be used for document scoring in IR. A representation 402 of a query 403 generated by a query-side encoder or query encoder 404 is compared using a comparator block 410 to representations 405 of each of a plurality of candidate sequences, e.g., generated offline, online, or a combination of offline and online, for a document collection 406 by a document-side encoder or document encoder 408. The candidate sequences 405 may be respectively associated with candidate documents (or themselves are candidate documents) for information retrieval.

In some embodiments, the document-side encoder 408 and the query-side encoder 404 may be embodied in the same encoder, such as the encoder 300 (shown in FIG. 3). In other embodiments, to further improve efficiency of retrieval in example IR models, the document-side encoder 408 and the query-side encoder 404 can be separate encoders, as described in additional detail herein. The query-side encoder 404 may be embodied, for instance, in a differently-configured pretrained LM-based encoder, or in a model other than a pretrained LM-based encoder, such as but not limited to a tokenizer, for providing a representation of the query.

An example comparison (performed by the comparator block 410) between the representations 405, 402 generated by the document-side encoder 408 and the query-side encoder 404 may include, for instance, taking a dot product between the representations. This comparison may provide a ranking score. The plurality of candidate sequences associated with the representations 405 can then be ranked, e.g., based on the determined ranking score, and a subset of the documents 406 (e.g., the highest ranked set, a sampled set based on the ranking, etc.) can be retrieved. This retrieval can be performed during the first (ranking) and/or the second stage (reranking) of an IR method.

Training a Neural Ranker Model

An example training method for the neural ranker model 104 (shown in FIG. 1) will now be described. The neural ranker model 104 may include a document-side encoder 408 (shown in FIG. 4), an embodiment of which may be provided by an encoder configured as in encoder 300 (shown in FIG. 3). The neural ranker model 104 may further include a query-side encoder 404, an embodiment of which may be provided by the document-side encoder 408, by a separate encoder according to encoder 300 but configured differently than the document-side encoder, by a separate pretrained LM-based encoder other than encoder 300, by an encoder not based on a pretrained LM, by a tokenizer, etc.

Training the neural ranker model 104 may begin by initializing parameters of the model(s) including the document-side and query-side encoders, e.g., weights and biases. The parameters may be iteratively adjusted after evaluating an output result produced by the model 104 for a given input against the expected output. Some parameters may be pretrained, such as but not limited to parameters of a pretrained LM such as an MLM. Initial parameters may additionally or alternatively be (for example) randomized or initialized in any suitable manner.

The neural ranker model 104 may be trained using a dataset including a plurality of documents. The dataset may be used in batches to train the neural ranker model 104. The dataset may include a plurality of documents including a plurality of queries. For each of the queries the dataset may further include at least one positive document (a document associated with the query) and at least one negative document (a document not associated with the query). Negative documents can include hard negative documents, which are not associated with any of the queries in the dataset (or in the respective batch), and/or negative documents that are not associated with the particular query but are associated with other queries in the dataset (or batch). Hard documents may be generated, for instance, by sampling a model such as but not limited to a ranking model.

Training a Neural Ranking Model with In-batch Negatives

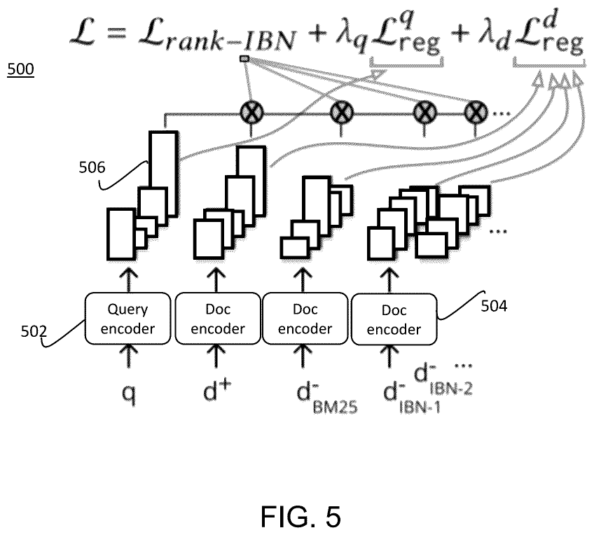

FIG. 5 shows an example training method for a neural ranking model 500 employing an in-batch negatives (IBN) sampling strategy. The neural ranking model 500 includes a query encoder 502 and a document encoder (doc encoder) 504. The document and query encoders 502, 504 may both be embodied in an encoder such as the encoder 300 (shown in FIG. 3) or may be embodied in separate encoders such as the encoder 300 or other encoders.

Let s(q, d) denote the ranking score obtained from dot product between q and d representations, e.g., representations generated from Equation (2), or representations provided by other encoders (for instance, if the query and documents encoders are separate). Given a query qᵢ in a batch, a positive document dᵢ⁺ a (hard) negative document dᵢ⁻ (e.g., coming from sampling a ranking function, e.g., from BM25 sampling), and a set of negative documents in the batch provided by positive documents from other queries {d_{i,j}⁻}ⱼ, the ranking loss can be interpreted as the maximization of the probability of the document dᵢ⁺ being relevant among the documents dᵢ⁺, dᵢ³¹, and {d_{i,j}⁻}ⱼ:

$${ℒ}_{rank - IBN} = - log \frac{{e}^{s ( {q}_{i} , {d}_{i}^{+} )}}{{e}^{s ( {q}_{i} , {d}_{i}^{+} )} + {e}^{s ( {q}_{i} , {d}_{i}^{-} )} + {\sum }_{j} {e}^{s ( {q}_{i} , {d}_{i , j}^{-} )}} \qquad ( 3 )$$

The example neural ranker model 500 can be trained by minimizing the loss in Equation (3).

Sparsity Regularization Using FLOPS Regularizer

The ranking loss may be supplemented to provide for regularization. One example regularization that may be used is sparsity regularization. However, other regularizations may be used as disclosed herein.

Learning sparse representations has been employed in methods such as SNRM (e.g., Zamani et al.) via [symbol] ₁ regularization. However, minimizing the [symbol] ₁ norm of representations does not result in the most efficient index, as nothing ensures that posting lists are evenly distributed. This is even truer for standard indexes due to the Zipfian nature of the term frequency distribution.

To obtain a well-balanced index, Paria et al., “Minimizing FLOPs to Learn Efficient Sparse Representations”, arXiv:2004.05665, 2020, which is incorporated herein by reference, discloses the FLOPS regularizer, a smooth relaxation of the average number of floating-point operations (FLOPs) necessary to compute the score of a document, and hence directly related to the retrieval time.

FLOPS regularization may be used in example methods for fine-tuning a pretrained language model for information retrieval. Alternatively or additionally, FLOPS regularization may be used for pretraining and/or middle training of a language model or pretrained language model, as described in more detail below.

The FLOPS regularizer can be defined using aⱼ as a continuous relaxation of the activation (i.e., the term has a non-zero weight) probability pⱼ for token j, and estimated for documents d in a batch of size N by

$${\overline{a}}_{j} = \frac{1}{N} {\sum }_{i = 1}^{N} {w}_{j}^{( {d}_{i} )} .$$

This provides the following regularization loss:

$${ℓ}_{FLOPS} = {\sum }_{j ∈ V} {\overline{a}}_{j}^{2} = {\sum }_{j ∈ V} {( \frac{1}{N} {\sum }_{i = 1}^{N} {w}_{j}^{( {d}_{i} )} )}^{2}$$

This differs from the [symbol] ₁ regularization used in SNRM in that the āⱼ are not squared: using [symbol] _{FLOPS} thus pushes down high average term weight values, giving rise to a more balanced index.

Example neural ranker models may combine one or more of the above features to provide training, including but not limited to end-to-end training, of sparse, expansion-aware representations of documents and queries. For instance, example models can learn the log-saturation model provided by Equation (2) by jointly optimizing ranking and regularization losses:

[symbol]

= [symbol] _{rank-IBN}+λ_{q} [symbol] _{reg}^{q}+λ_{d} [symbol] _{reg}^{d} (4)

In Equation (4), [symbol] _{reg} is a sparse regularization (e.g., [symbol] ₁ or [symbol] _{FLOPS}). Two distinct regularization weights (λ_{q} and λ_{d}) for queries and documents, respectively, can be provided in the example loss function, allowing additional pressure to be put on the sparsity for queries, which is highly useful for fast retrieval.

Max Pooling

Neural ranker models may also employ pooling methods to further enhance effectiveness and/or efficiency. For instance, by straightforwardly modifying the pooling mechanism disclosed above, example models may increase effectiveness by a significant margin.

An example max pooling method may change the sum in Equation (2) above by a max pooling operation:

$${w}_{j} = {max}_{i ∈ t} log ( 1 + ReLU ( {w}_{ij} ) ) \qquad ( 5 )$$

This modification can provide improved performance, as demonstrated in experiments.

Neural Ranking Model without Query Expansion

As provided above, it is not necessary for the document and query encoders to be embodied in the same encoder, but instead separate encoders may be used. For example, the document encoder 408 may be embodied in an encoder such as the encoder 300 including the pretrained LM model 320 for document expansion, whereas the query encoder 404 can be configured to encode the query without query expansion. This can provide a document expansion-only neural ranking model and method.

Document expansion-only models can be inherently more efficient, as documents can then be pre-computed and indexed offline, while providing results that remain competitive. Such methods can be provided in combination with other features provided herein.

In document expansion only methods, there are no query expansions nor term weighting, and thus a ranking score s(q, d) can be provided simply by comparing a tokenization of the query in the vocabulary (e.g., provided by the query encoder 404) to (e.g., pre-computed) representations of documents that can be generated by the document encoder 408 using a pretrained LM-based model:

s(q,d)=Σ_{j∈q}wⱼ^{d} (6)

Enhancing Performance Using Distillation Training

Example training methods may incorporate distillation. Distillation can be provided in combination with features of any of the example models or training methods. An example distillation-based training method may be based on methods disclosed in Hofstatter et al., Improving Efficient Neural Ranking Models with Cross-Architecture Knowledge Distillation, arXiv:2010.02666, 2020. Distillation techniques can be used to further boost example model performance, as demonstrated by experiments.

Example distillation training can include at least two steps. In a first step, both a first stage retriever, e.g., as disclosed herein, and a reranker, such as those disclosed herein (as a nonlimiting example, HuggingFace, as provided by huggingface.co/cross-encoder/ms-marco-MiniLM-L-12-v2) are trained using triplets (e.g., a query q, a relevant passage p⁺, and a non-relevant passage p⁻), e.g., as disclosed in Hofstatter et al., 2020, Improving Efficient Neural Ranking Models with Cross-Architecture Knowledge Distillation. arXiv:2010.02666. In a second step, triplets are generated with harder negatives using an example model trained with distillation, and the reranker is used to generate the desired scores.

A ranker model may then be trained from scratch (e.g., without prior pretraining or training) using these triplets and scores. The result of this second step provides a distilled ranker model.

Efficiency Enhancements for Sparse Information Retrieval Models

For sparse information retrieval (IR) models based on pretrained LMs, it is useful to consider not only performance, but also latency and efficiency. Search engines, for instance, currently process billions of queries daily. A certain degree of efficiency may be expected or desired when using IR models in first-stage rankers, which may select on the order of thousands of documents out of a large collection.

Sparse retrieval models perform matching at the token (e.g., word) level, and can therefore use an inverted index for scoring. For search engines incorporating sparse retrieval models, it is common to optimize an inverted index with compression techniques or adopt an efficient two-stage ranking pipeline to improve performance while maintaining an acceptable latency. In contrast to pretrained LM-based dense retrieval methods for IR tasks, pretrained LM-based sparse IR models use a lexical (sparse) base, taking advantage of the pretrained LMs to perform document and (sometimes) query expansion while also doing term reweighting.

However, measuring the latency of pretrained LM-based sparse IR models is challenging. As one reason, there can be multiple testing conditions. For instance, a standard dense bi-encoder may rely on multiple GPUs to perform a search, while other systems may rely only a single core, or multi-core implementations. Latency and efficiency concerns may thus be overlooked when evaluating such models, even though there may be an expectation of some minimum efficiency for IR (e.g., for rankers).

A significant amount of research has been performed relating to optimizing retrieval with inverted indexes. Strong mono-CPU retrieval numbers have been achieved with conventional sparse retrieval models, making it simple to improve scalability, e.g., by adding CPUs. For dense retrieval, on the other hand, multi-threaded CPUs and GPUs are common. Additionally, integrating a sparse ranker into an existing IR system may be less costly compared to the integration of a dense retrieval system.

By incorporating encoders 300 based on pretrained LMs in which documents are represented by tokens with a variable quantity of tokens per document, sparse retrieval methods as provided herein may exhibit a natural trade-off between efficiency (e.g., latency or queries per second) and effectiveness. As disclosed above, this trade-off can be regulated in some example methods via a regularization factor that considers an expected number of floating-point operations (FLOPS). Larger documents or queries improve effectiveness and reduce efficiency.

It would be desirable to further improve efficiency of sparse retrieval methods using pretrained LMs for IR applications or environments. For instance, it would be desirable to improve or optimize efficiency for a mono-CPU retrieval environment.

In additional embodiments provided herein, sparse retrieval methods using pretrained LMs are further configured for improving efficiency using one or more efficiency enhancements. Such efficiency enhancements can improve efficiency of sparse IR models based on pretrained LMs with a lesser effect on effectiveness, and reduce a latency gap between example sparse retrieval models based on pretrained LMs and conventional retrieval systems.

Among other enhancements, example sparse retrieval methods using pretrained LMs may incorporate or exploit training techniques such as searching for appropriate hyperparameters, improving the data used for training, or a combination of both. For instance, as described in more detail herein, training of sparse retrieval models may include optimizing a teacher for distillation (e.g., to provide more accurate evaluations of query-document pairs) and/or include a more varied set of negatives (e.g., from different retrieval models). Such training techniques, alone or in combination, can provide efficiency improvements.

Separately or in addition to the above, example sparse retrieval methods using pretrained LMs may exhibit enhanced retrieval efficiency by incorporating or exploiting various efficiency enhancement techniques, such as: separating the document and query encoders; changing the query regularization, providing middle training of a pretrained language mode (LM) with a floating-point operations (FLOPS) regularization; and/or providing a more efficient (e.g., smaller and/or faster) pretrained LM query encoder.

Incorporating one or more of the above techniques individually or cumulatively, e.g., in adaptations or configurations of models provided herein, can enhance the efficiency of example sparse retrieval methods even over otherwise similar methods employing improved hyperparameters and teachers. For instance, combining each of the above efficiency enhancements (separating document and query encoders, changing query regularization to L1, middle training of a pretrained LM with a FLOPS regularization, and providing a smaller pretrained LM query encoder), along with searching for appropriate hyperparameters and Improving data used for training efficiency improvements, was shown in experiments to reduce latency by fiftyfold (50×) compared to baselines. Further, implementing the above efficiency enhancements in combination was shown to reduce latency by fivefold (5×) even over otherwise similar methods that incorporated the above training techniques of searching for appropriate hyperparameters and Improving data used for training efficiency improvements, but omitted the others. Experiments also demonstrated that such a combination of efficiency improvements did not incur in-domain effectiveness loss, and that out-of-domain loss, if present, can be addressed with only a small efficiency loss.

Experiments described in more detail herein validated example efficiency enhancement approaches using a current efficient sparse retrieval framework, PISA (A. Mallia et al., Pisa: Performant indexes and search for academia. Proceedings of the Open-Source IR Replicability Challenge, 2019.) and evaluated effectiveness both in-domain (e.g., using MS MARCO P. Bajaj et al., Ms marco: A human generated machine reading comprehension dataset. In InCoCo@NIPS, 2016.) and out-of-domain (evaluated using BEIR (N. Thakur et al., BEIR: A heterogenous benchmark for zero-shot evaluation of information retrieval models. CoRR, abs/2104.08663, 2021)).

The above improvements in combination can be used to provide a neural sparse retriever based on pretrained LMs that can achieve similar efficiency to current most-efficient sparse retrieval methods (e.g., BM25 without stop-words), while improving effectiveness on in-domain data compared to sparse retrieval methods without such efficiency enhancements. Additionally, the above example improvements in combination can improve performance (e.g., 2×) over the current most efficient sparse retrieval methods, while achieving comparable results on out-of-domain data to sparse retrieval methods without such efficiency enhancements. However, it will be appreciated that any one, or a subset, of these efficiency enhancements where practicable may instead be incorporated into a neural sparse retriever.

Example Applications of Efficiency Enhancement Methods

For explanatory purposes, efficiency enhancement methods will now be described with respect to an example sparse retrieval model using pretrained LMs referred to herein as SPLADE, and to example variations thereof. However, it will be appreciated that such efficiency enhancements may likewise be incorporated into other example sparse retrieval model using pretrained LMs other than the illustrative SPLADE model. Sparse model representations, unlike dense model representations which are low-dimensional, large and opaque, are high-dimensional, light and more transparent and explainable. Sparse models effectively index documents based on words, while dense models require greater computational resources. The SPLADE model integrates dense language representation output in a sparse model, after which a relevance weight is computed for each word and based on those weights some words are dropped while others are integrated.

SPLADE is based on the transformer encoder BERT (J. Devlin et al., BERT: pre-training of deep bidirectional transformers for language understanding. CoRR, abs/1810.04805, 2018) for encoding documents and queries. The BERT token space is used to predict term importance, which is based on the logits of a pretrained LM trained using Masked Language Model (MLM) methods, such as pretrained LM 320.

Referring to the operation of SPLADE's IR model including its encoder, let D be a document and Q a query, and let wᵢⱼ be the logit for the ith token in D for the probability of term j. The weight wᵢⱼ is how important the pretrained LM considered the term j of the token space to the input term i. The example model then takes the importance for each token in the document sequence and combines them (e.g., max pools them) to generate a vector in the BERT vocabulary space.

Each item can be encoded into a representation R, which is a vector of dimensions t, where t is the amount of tokens in the transformer vocabulary.

To rank the documents, a score can be used, such that for each given query (Q) the score of a document D can be given by the following formula:

$$s ( D , Q ) = {\sum }_{j = 0}^{\vert {t}_{Q} \vert} {{max}^{\vert {t}_{D} \vert}}_{i = 0} {( {R}_{D} \cdot {R}_{Q} )}_{i , j}$$

To improve efficiency for document ranking, and thus retrieval, one can precompute (e.g., offline) the representations for all documents (D∈ [symbol] ) so that during inference time only the query representation needs to be computed. In this way, only one forward pass is needed on the neural network. Retrieval thus becomes a problem of retrieving the nearest neighbors.

Regularization and Distillation

To generate features that are efficient for nearest-neighbor retrieval, SPLADE uses a regularization such as a FLOPS regularization (e.g., B. Paria et al.), to control the amount of expected operations, e.g., as described above. Example sparse retrieval models such as SPLADE can further be optimized via distillation, as described above.

Such models can jointly optimize, for instance, the distance between teacher and student scores, and can minimize the expected mean FLOPS of the retrieval system. This joint optimization can be described as:

[symbol]

= [symbol] _{distillation}+λ_{q} [symbol] _{FLOPS}^{q}+λ_{d} [symbol] _{FLOPS}^{d}

Where [symbol] _{FLOPS} is the sparse FLOPS regularization and [symbol] _{distillation} is a distillation loss between the scores of a teacher and a student (e.g., using KL Divergence as the loss, and a cross-ranker disclosed in Rodrigo Nogueira and Kyunghyun Cho. 2019. Passage Re-ranking with BERT, arXiv:1901.04085 [cs.IR] as teacher). As there are two distinct regularization weights, one can put more sparsity pressure on either queries or documents, but always considering the amount of FLOPS.

SPLADE-Doc

A variation of SPLADE, referred to as SPLADE-doc, provides a document encoder, but not a query encoder. In this adapted model, no query expansion is performed as with the document encoder, but instead only query tokenization is done, with all query terms having the same importance.

Additional Efficiency Enhancements

Since example representations are sparse, even a naïve brute force approach, e.g., scoring all documents and then sorting the final results, may be efficient enough for some performance benchmarks. However, such an approach may be relatively less efficient when evaluated under the guise of some traditional sparse retrieval frameworks, such as Anserini (P. Yang et al., Anserini: Reproducible ranking baselines using lucene. Journal of Data and Information Quality (JDIQ), 10(4):1-20, 2018) and PISA (A. Mallia et al., 2019). This is because naïve brute force approaches only need to optimize for the amount of estimated operations, where such traditional sparse retrieval frameworks often do not need to compute all of the scores, but instead only a fraction based on index statistics.

In this sense, refined strategies pay an overhead at the start of the operation (e.g., detecting which documents do not need to be scored, which order to score the query to minimize costs, etc.). Such overhead is closely linked to pre-computed index statistics and query size.

Thus, larger index statistics and, especially, large query size can result in a larger performance overhead. In some environments, it may be desirable to further improve efficiency beyond the improvements provided by the FLOPS regularization described above.

Costs related to serving example sparse retrieval models such as SPLADE include costs relating to encoding (both documents and queries) and costs related to retrieval. Considering the encoding cost first, example sparse retrieval methods provided herein can have a very small (even infinitesimal) encoding-related cost compared to their solution. In other words, example methods can be more cost effective for encoding than other state-of-the-art models.

However, significant additional efficiency improvement can result from reducing query sizes, as opposed to, say, a sole or primary focus on the FLOPS measure. For instance, in mono-threaded systems, there are many techniques that can reduce the amount of effective FLOPS computed per query, but query size is then a major bottleneck.

To further reduce the costs of retrieval and query encoding, example methods herein can incorporate one or more of the following efficiency improvement techniques, described in more detail herein: separating document and query encoders; changing query regularization to L1, middle training of a pretrained LM with a FLOPS regularization; and providing a smaller pretrained LM query encoder. Though each of these efficiency enhancement techniques may be used alone or in combination, a combination of these four techniques along with two training techniques (searching for appropriate hyperparameters, improving the data used for training) has been shown to reduce the costs of retrieval and query encoding, even to the same level as currently most-inexpensive sparse retrieval methods, such as BM25 (S. Robertson, “The Probabilistic Relevance Framework: BM25 and Beyond”, in Foundations and Trends in Information Retrieval, 3(4):333-389, 2009).

Additionally, example methods incorporating a combination of these six efficiency improvement techniques were shown to be as effective in terms of performance as methods disclosed elsewhere herein, including example state-of-the-art sparse retrieval methods such as SLADEv2 (T. Formal, C. Lassance, B. Piwowarski, and S. Clinchant. “SPLADE v2: Sparse lexical and expansion model for information retrieval”, CoRR, abs/2109.10086, 2021, which is herein incorporated by reference), while being as efficient in terms of cost as more traditional and inexpensive methods, such as BM25. Sparse retrieval methods incorporating such efficiency enhancement techniques can thus provide a highly useful combination of effectiveness and efficiency for neural information retrieval.

A detailed discussion of each of these (six) efficiency enhancement techniques as applied to the illustrative SPLADE models follows. Though efficiency and effectiveness benefits can be cumulative when incorporating combined techniques, it will be appreciated that not all techniques are necessary, and that a subset of such techniques can be incorporated into example sparse retrieval models. Further, the listing and order of the six techniques below is for illustration and reference only, and is not intended to limit the invention to a certain order of incorporating efficiency enhancements, nor to limiting the possible subsets or subcombinations of efficiency enhancements that may be used.

I) Searching for Appropriate Hyperparameters

More efficient IR networks can result from modifying or optimizing one or more training hyperparameters. For instance, for SPLADE, the distillation loss can be changed from MarginMSE (Sebastian Hofstätter, Sophia Althammer, Michael Schröder, Mete Sertkan, and Allan Hanbury, “Improving Efficient Neural Ranking Models with Cross-Architecture Knowledge Distillation”, arXiv:2010.02666, 2020) to KL Divergence (Geoffrey Hinton, Oriol Vinyals, Jeff Dean, “Distilling the knowledge in a neural network”, arXiv:1503.02531, 2015). KL Divergence was more stable and had smaller norms.

Additionally, an appropriate set of hyperparameters ((λ_{q}, λ_{d}) for the optimization) can be searched for in order to have acceptable query and document sizes. For experimental trained SPLADE models three sets of parameters were adopted: Small (S), Medium (M), and Large (L), where S can be seen as the baseline (the sparsest model), M relaxes the sparsity constraint in the document side (i.e., larger documents) but has the same sparsity constraint on the query side as S, and L has the same sparsity constraint on the document side as M but a more relaxed sparsity constraint on the query side (i.e., larger queries).

II) Improving Data Used for Training

Additional improvements can come from optimizing the data and the model used for distillation. An example objective is to improve the effectiveness of the networks previously used (e.g., for SPLADE), while avoiding increasing the cost of inference.

In an example method, the distillation data was moved from a more traditional set (Sebastian Hofstätter, Sophia Althammer, Michael Schröder, Mete Sertkan, and Allan Hanbury, “Improving Efficient Neural Ranking Models with Cross-Architecture Knowledge Distillation” arXiv:2010.02666, 2020) to one available from huggingface (see huggingface.co/datasets/sentence-transformers/msmarco-hard-negatives). The previous data used negatives from BM25, while the latter uses negatives from various sources and a more powerful teacher.

It is also possible to pretrain and/or middle train the language model on a target collection (e.g., an in-domain collection), as opposed to performing such training on a generic collection (or providing an off-the-shelf PLM pretrained using a generic collection). Pretraining or middle training on a target collection can provide a specialized ranker (or reranker) model and reduce training time, with little or no drop in effectiveness.

III) Separating Document and Query Encoders

Another efficiency enhancement technique for sparse retrieval methods is provided by decoupling the document and query encoders. For instance, it can be difficult to achieve smaller queries if the encoder for both documents and queries is the same and there is nothing to differentiate them. Even very large differences in λ_{q}, λ_{d} may not produce smaller queries in such cases.

Using separate networks for document and query encoding, respectively, allows each network to be specialized to the type of data they are dedicated to. This is useful, for example, for performing asymmetric search (e.g., short, to the point queries versus larger general documents). The model also does not need to find an optimal trade-off for documents and queries, as it does for a single model. Specializing the encoding network to the input further can provide for more control of the amount of tokens in queries and documents. This additionally provides for the use of different architectures for each encoder, which can further improve efficiency.

Encoders for documents and queries may be separately or independently configured, for instance, in terms of one or more of architecture, size, model weights, training, regularization, hyperparameters, location, etc. It is possible for the document and query encoding networks to be linked to one another and/or have one or more shared or overlapping features, which still being considered separate networks.

IV) L1 Regularization for Queries

The asymmetry and specialization that can be provided by separating the encoding networks for document and query encoding (via enhancement III) above) can additionally be used to exploit other efficiency enhancing techniques. For instance, it may not be useful to optimize a particular regularization (e.g., a FLOPS regularization, as disclosed in Paria et al.) for queries as opposed to documents, or vice versa.

While FLOPS regularization may be useful for document representation, it may not be the best measure to account for latency of a retrieval system. For instance, a FLOPS regularization can serve as a way to balance the index generated by the document, but it may not be necessary or useful to enforce that query tokens are also balanced around the index. Depending on the biases of the dataset, this may not even be desirable as a property. For example, depending on the dataset domain, queries may always start with a small subset of words (e.g., how, why, what), and removing this bias to force a sparse retrieval output for queries to be balanced over the entire token space may not be ideal.

Thus, example methods can use a different regularization such as the L1 norm (e.g., a simple L1 loss) for the regularization of the query encoding (query side), while a regularization such as a FLOPS regularization is provided for the document encoding (document side). The L1 norm is a closer approximation of the L0 norm (because the L0 norm is non-differentiable, it cannot be used directly on the loss).

Retrieval time is a function of the query length under a mono-CPU framework (for instance). Controlling the query length can thus be used to control the latency. Controlling for the L0 norm in the query encoding can be more useful for the objective of reducing the query size. This in turn can reduce retrieval overhead, and thus reduce the latency of sparse retrieval models.

Improving sparse regularization with this technique can increase the effectiveness of example sparse retrieval models in addition to increasing efficiency. For instance, adding too many words during query expansion may add noise to representations, which can perturb learning. Furthermore, FLOPS is not very well motivated on the query side, as it is not desirable to provide spread query terms (a query index is not needed). The use of L1 regularization instead of FLOPS regularization on the query side alone can improve the effectiveness of example sparse regularization models.

V) Middle Training and Enhanced Pretraining of a Language Model with FLOPS Regularization

Pretrained language models (LMs) can be further improved for information retrieval by incorporating a “middle training” step; that is, a step (or combination of steps) between pretraining (where the LM may be trained for predicting, e.g., without constraints) and fine-tuning a model such as an encoder or a decoder including the LM for IR. It is also possible that middle training can occur concurrently with pretraining to provide enhanced pretraining, and then be followed by fine-tuning. In an example middle training method, the network is optimized without any supervision, but with a guidance to the final fine-tuned task (e.g., IR).

Middle training approaches have been used for dense retrieval, e.g., Co-Condenser, as disclosed in L. Gao and J. Callan. Unsupervised corpus aware language model pre-training for dense passage retrieval. arXiv preprint arXiv:2108.05540, 2021. Gao and Callan discloses that pretrained LMs used to initialize deep retrieval models (e.g., BERT-based models) are good for MLM, but are not ideally adapted to IR, since IR may involve the condensing of large amounts of information into a single vector. Middle training is thus used to adapt the pretrained LM to IR to improve performance (e.g., better similarity).

In Co-Condenser, two steps of middle training are performed. In a first step, information is condensed into the CLS token (at the start of each sentence) with masked language modeling (MLM); that is, a transformer encoder is built with a structure input>early>late>head, and the first step trains with an MLM task on the head. The head takes as input sequences provided by the “late” encodings of the CLS token and the “early” encodings of the rest of the sentence. The second step is jointly training unsupervised contrastive and MLM losses.

Other example middle training approaches for dense networks are disclosed in G. Izacard et al., Towards unsupervised dense information retrieval with contrastive learning, arXiv preprint arXiv:2112.09118, 2021; and A. Neelakantan et al. Text and code embeddings by contrastive pre-training. arXiv preprint arXiv:2201.10005, 2022.

However, such middle training approaches have not previously been used for enhancing sparse information retrieval, let alone for enhancing efficiency of sparse information retrieval. By contrast, example methods can incorporate a relatively simple middle training step (which can include one or multiple steps) focused on sparse retrieval. Example middle training steps described herein can also be used in enhanced pretraining to pretrain an LM model from scratch (e.g., without prior pretraining or training).

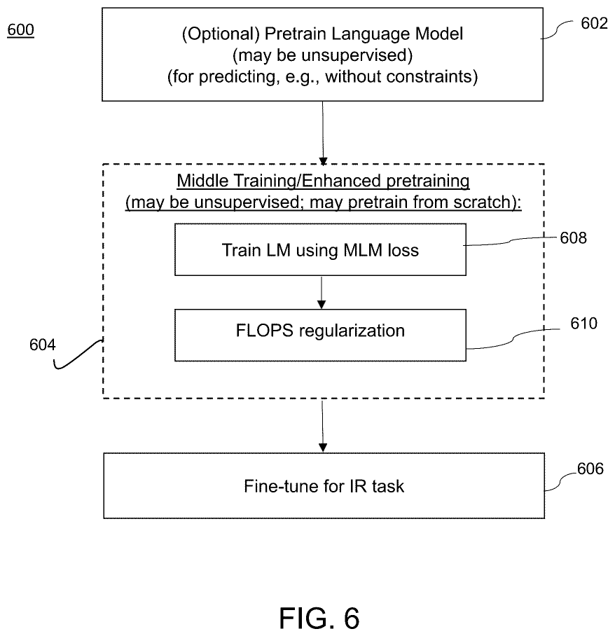

FIG. 6 shows an example training method 600 for an LM of IR model that incorporates middle training or enhanced pretraining. The LM may be, but need not be, pretrained at 602 for predicting, e.g., without constraints, as will be understood by an artisan. For example, the MLM loss may include or incorporate a standard MLM loss such as disclosed in J. Devlin et al., BERT: pre-training of deep bidirectional transformers for language understanding. CoRR, abs/1810.04805, 2018.

An example middle training or enhanced pretraining step 604 is provided after, or concurrently with (or in place of), pretraining the LM 602 and before fine-tuning for an IR task at 606. The LM may be pretrained from scratch (e.g., without prior pretraining or training) at step 604 if the LM is not pretrained before the middle training. The example middle training and/or enhanced pretraining at 604 includes training the LM (whether or not previously pretrained) at 608 using a masked language model (MLM) loss, combined with FLOPS regularization at 610.

For example, the MLM loss at 608 may include or incorporate a standard MLM loss such as disclosed in J. Devlin et al., 2018. This standard MLM loss, for instance, may (but need not) be the same as or similar to an MLM loss used for pretraining (e.g., optional pretraining step 602) if the LM was pretrained. In an example middle training or enhanced pretraining method of the LM, the standard MLM loss can be modified or supplemented. For instance, the MLM logits y_{logits} may go through a concave activation function (e.g., log (1+ReLU(y_{logits})), or other concave activation function), which function bounds values and introduces sparsity. This defines an MLM loss over a sparse set of logits, which provides for document expansion, but with sparsity and with concave activation.

An additional term, FLOPS regularization, can be added to the loss to force the logits to not only be nonnegative, but to be sparse, and balances vocabulary. This helps to precondition the LM for downstream use. The example FLOPS regularizer can be defined using aⱼ as a continuous relaxation of the activation (i.e., the term has a non-zero weight) probability pⱼ for token j, and estimated for documents d in a batch of size N by

$${\overline{a}}_{j} = \frac{1}{N} {\sum }_{i = 1}^{N} {w}_{j}^{( {d}_{i} )} ,$$

to provide a regularization loss:

$${ℒ}_{FLOPS} = {\sum }_{j ∈ V} {\overline{a}}_{j}^{2} = {\sum }_{j ∈ V} {( \frac{1}{N} {\sum }_{i = 1}^{N} {w}_{j}^{( {d}_{i} )} )}^{2}$$

A max pooling of the overall sequence, such as described by example above, can be performed to provide a representation at the token (e.g., word) level:

$${w}_{j} = {max}_{i ∈ t} log ( 1 + ReLU ( {w}_{ij} ) )$$

On this final representation, the FLOPS regularization forces sparsification (and uniformity) over the overall vocabulary. The total loss can thus be represented as follows using the example concave activation function, where λ is optionally provided as a weighting factor:

[symbol]

= [symbol] _{MLM}(y_{logits})+ [symbol] _{MLM}(y_{ACTIVATION})+λ [symbol] _{FLOPS}(y_{ACTIVATION})

y_{ACTIVATION}=log(1+ReLU(y_{logits}))

Using this middle training or enhanced pretraining step 604, the network can be in an improved state for fine-tuning, as it preconditions the MLM logits to be sparse and distributed. Without wishing to be bound by theory, it is believed that the FLOPS regularization 610 in the middle training step 604 penalizes the overpresence of frequent words in the MLM predictions. Therefore, at the fine-tuning stage, the network may expand documents and queries with less noise. Both efficiency and effectiveness can be enhanced for sparse retrieval models using example middle training methods.

The example middle training or enhanced pretraining step 610 also can facilitate the extension of example sparse retrieval methods to other LMs, including but not limited to pretrained LMs. For example, pretrained LMs such as but not limited to RoBERTA may be used for sparse IR models, whereas without either middle training or enhanced pretraining, or manually changing parameters, fine-tune training may be unfeasible, since the LM may not integrate well into a sparse retrieval context. Middle training or enhanced pretraining may also allow application of the FLOPS constraint, as exemplified above.

VI) Smaller (and/or Faster) Query Encoders

A significant factor when determining the latency of pretrained LM-based models is the latency of the query encoder, which can be quite costly. As described above, by providing separate networks for the document and query encoders, it also becomes possible to use different architectures for each encoder. As the query encoding may otherwise provide a bottleneck, using smaller (that is, smaller and/or more efficient in any suitable aspect) pretrained LMs for the query encoder can significantly improve efficiency of sparse retrieval models. If these smaller pretrained LMs are also middle trained and applied for query encoding, this efficiency enhancement can be further exploited with little impact on effectiveness.

As a nonlimiting example, the document encoder may include a relatively larger and/or less efficient pretrained LM such as but not limited to BERT or DistilBERT, while the query encoder may include a relatively smaller pretrained LM such as but not limited to BERT-Tiny (P. Bhargava et al., Generalization in nli: Ways (not) to go beyond simple heuristics, 2021). Other combinations of (larger) document and (smaller) query encoders are possible. In other sparse retrieval models, the document and query encoders can use similar architectures.

As another example, an IR system can be provided without a query encoder (e.g., the example SPLADE-doc model). This can be further adapted by, for instance, removing the stop words of the queries and retraining the IR model.

Combining Efficiency Enhancement Techniques

Example efficiency improvements III)-VI) provided herein, whether alone or in any combination (one, two or more, three or more, all four, etc.), and whether or not combined with example training techniques I) and/or II), can significantly reduce the computation cost of deploying neural rankers incorporating sparse retrieval methods. Effectively controlling the cost of such methods is highly useful in practice. Example IR models herein incorporating a combination of efficiency improvement techniques can be operated with a cost comparable to or similar to (e.g., nearly unchanged from) sparse retrieval solutions such as BM25, while still providing improvements from neural ranking. Similar frameworks can be used for different methods, and these frameworks can be configured as needed to incorporate one or more of the above efficiency improvements.

### EXPERIMENTS

To assess example efficiency-enhancement techniques, models based on SPLADE and variations thereof and incorporating the above efficiency enhancement methods were trained and evaluated on the MS MARCO passage ranking dataset (P. Bajaj et al., Ms marco: A human generated machine reading comprehension dataset, In InCoCo@NIPS, 2016) in the full ranking setting. The MS MARCO dataset contains approximately 8.8M passages, and hundreds of thousands of training queries with shallow annotation (≈1.1 relevant passages per query on average). The development set contains 6980 queries with similar labels.

Additional experiments considered evaluation using the TREC-DL 2019 evaluation set, which provides fine-grained annotations from human assessors for a set of 43 queries, as well as a subset of 13 out of the 18 datasets of the BEIR benchmark (N. Thakur et al., “BEIR: A heterogenous benchmark for zero-shot evaluation of information retrieval models”, arXiv:2104.08663, 2021), which judges the zero-shot performance of information retrieval (IR) models over diverse sets of tasks and domains. A document-at-a-time retrieval setup was used.

For comparison, sparse retrieval models were evaluated without the example improvements. Then, each improvement enumerated above was added to an example sparse retrieval model in a step-by-step manner, namely: I) Searching for appropriate hyperparameters; II) Improving data used for training; Ill) Separating document and query encoders; IV) Changing query regularization to L1, V) Middle training of a PLM with a FLOPS regularization; and VI) Smaller PLM query encoder.

To compute efficiency, all experiments were performed in the same machine, including an INTEL™ XEON™ Gold 6338 CPU @ 2.00 GHz and sufficient RAM memory to preload indexes, models, and queries on memory before starting the experiment. All batch sizes were set to 1, limiting the experiment to using only one core. Experiments were performed using Anserini (P. Yang et al., “Anserini: Reproducible ranking baselines using lucene”, Journal of Data and Information Quality (JDIQ), 10(4):1-20, 2018) and PISA for retrieval, and PyTorch for document/query encoding. Efficiency experiments with PyTorch used the benchmarking tool from the transformers library (T. Wolf et al., “Transformers: State-of-the-art natural language processing”, in Proceedings of the 2020 Conference on Empirical Methods in Natural Language Processing: System Demonstrations, pages 38-45, Online, October 2020, Association for Computational Linguistics).

The latency of the query encoder pretrained LMs was measured using a sequence length of 8 for average latency and 32 for 99 percentile latency. Latency was computed as a simple addition of query encoding and retrieval time (which is measured on PISA). The DistilBERT query encoder had an average latency of 45.3 ms and a 99 percentile latency of 57.6 ms, while the BERT-tiny query encoder had an average latency of 0.7 ms and a 99 percentile latency of 1.1 ms.

SPLADE training: DistilBERT-base was used as the starting point if no other changes were made (namely steps V) and VI), which use a middle-trained DistilBERT and middle-trained BERT-tiny). SPLADE models were trained for 250 k with the ADAM optimizer, using a learning rate of 2e⁻⁵ with linear scheduling and a warmup of 6000 steps, and a batch size of 128. The last step was kept as a final checkpoint.

For the SPLADE-doc approach, the approach disclosed in T. Formal et al., SPLADE v2: Sparse lexical and expansion model for information retrieval, CoRR, abs/2109.10086, 2021, was followed, with a reduced training of only 50 k steps performed. A maximum length of 256 for input sequences was considered. To mitigate the contribution of the regularizer at the early stages of training, the method disclosed in Paria et al. was followed, and a scheduler for λ was used quadratically increasing λ at each training iteration, until a given step (50 k for SPLADE and 10 k for SPLADE-doc), from which it remained constant.

Middle-training was performed using default MLM parameters by Wolf et al. in “HuggingFace's Transformers: State-of-the-art Natural Language Processing” available at arXiv:1910.03771 (2020), with an added FLOPS regularization of λ=0.001. Concerning λ_{q}, λ_{d}, models I), II), and III) used the same hyperparameters: S=(0.1, 5e−3), M=(0.1, 5e−4), and L=(0.01, 5e−4), while models IV), V) and VI) used S=(5e−3, 5e−3), M=(5e−4, 5e−4), and L=(5e−4, 5e−4).

The experiments first reproduced those disclosed in J. Mackenzie et al., “Wacky weights in learned sparse representations and the revenge of score-at-a-time query evaluation”, arXiv:2110.11540, 2021, with PISA using the experimental setup. A stronger baseline, designated in figures herein as BM25†, was also added, which removes the stop-words from the queries.

Results

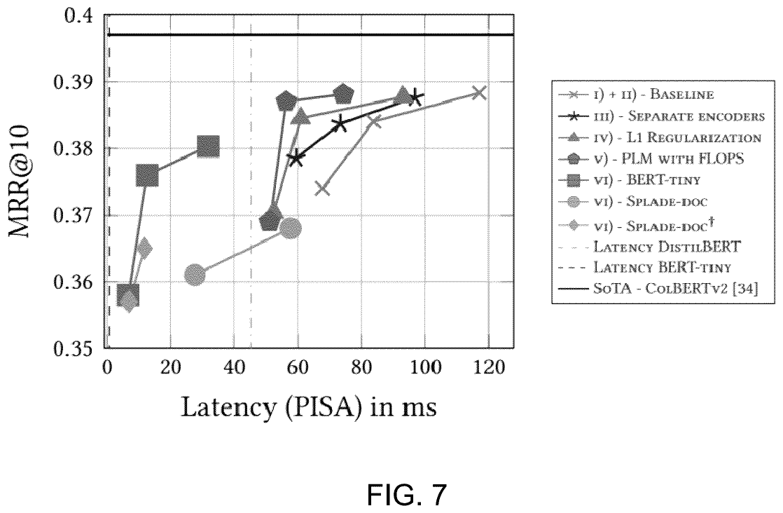

FIG. 7 shows results of the experimental reproduction, illustrating latency (PISA, in ms) and performance (MRR@10) using pytorch for pretrained LM inference and PISA for mono-CPU retrieval. For each model three points are shown, representing each combination of introduced above. SPLADEv2-distill is omitted in FIG. 7 for improved visibility, but it has a reported latency of 265 (Joel Mackenzie et al., “Wackyweights in learned sparse representations and the revenge of score-at-a-time query evaluation”, arXiv arXiv:2110.11540, 2021), and had a total latency measured on the experimental system of 691 ms.

As an initial efficiency improvement, and to achieve better baselines, performance of the SPLADEv2-distill model was enhanced using the first two training techniques I), II) described above, namely searching for appropriate hyperparameters and by improving the data used for training. FIG. 7 shows that these two improvements (shown as “I)+II)— Baseline”), even omitting the four additional efficiency enhancement techniques described above, allowed example sparse retrieval models to provide performance that is comparable to current state-of-the-art models. For example, the latency evaluated with PISA (and similarly with Anserini) was decreased by almost 10× of the latency from SPLADEv2-distil, while keeping similar or even improved performance on MS MARCO. Further, all models trained were close to the single-stage state-of-the-art retrieval performance of ColBERTv2 (Keshav Santhanam et al., 2021, Colbertv2: Effective and efficient retrieval via lightweight late interaction. arXiv preprint arXiv:2112.01488 (2021)) (at most a 10% reduction in MRR@10 performance).

For reducing retrieval latency, in addition to the baseline efficiency improvements I) and II), the four efficiency improvements according to example methods were incorporated one-by-one into the baseline sparse retrieval model: III) (separate query and document encoders); IV) (L1 regularization); V) (pretrained LM with FLOPS); and VI) (smaller Pretrained LM query encoder). Each efficiency enhancement “level” I), II), III), IV), V), and VI) in FIG. 7 represents the change provided by that enhancement in combination with all of the enhancements that came before. For example, improvement “V)” in FIG. 7 refers to the combination of I), II), III), IV), and V). It is also possible to include other sub combinations of enhancements I)-II) and efficiency improvements III)-VI), e.g., only I), II), III), and IV); only I), II), III), and V); only I) and III)-VI); etc.

As shown in FIG. 7, the combined efficiency enhancements III)-V) significantly reduced retrieval latency over the baseline that had only improvements I)-II). For the improved sparse retrieval model cumulatively incorporating each of efficiency improvements I)-V), the bottleneck became the DistilBERT inference latency, shown as a vertical line in FIG. 7, especially on PISA, instead of the retrieval latency. For example, the sparsest V) model had a gain of 1.2 ms compares to sparsest IV), which represents an approximate 20% reduction retrieval time (PISA), but an overall reduction of 2% (PISA+Pytorch).

To mitigate this bottleneck, and to further enhance efficiency by providing smaller pretrained LM query encoders, the pretrained LM for query encoding was replaced by a BERT-tiny encoder in one method, an example of efficiency enhancement technique VI). In another method illustrating efficiency enhancement technique VI) the SPLADE-doc method disclosed in T. Formal et al. was used (but efficiency enhanced using techniques I)-V)) and the query encoding was removed completely. These enhancements (enhancement VI)) aim to speed up the query encoder.

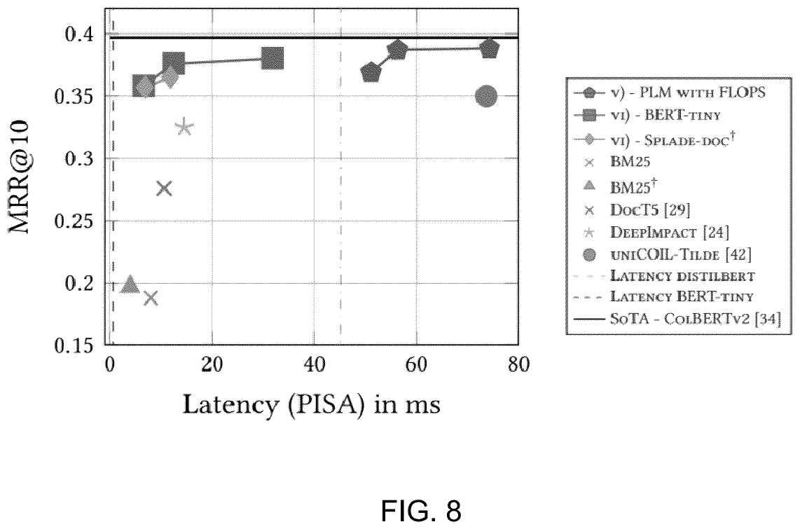

FIG. 7 shows a comparison of results from the example improvements, while FIG. 8 shows a comparison of example efficiency-improved sparse retrieval methods with state-of-the-art methods (BM25, BM25†, DocT5, DeepImpact, UniCOIL-Tilde; t refers to queries without stop-words). The results show that using a smaller query encoder model such as BERT-tiny (VI)—BERT-tiny, where VI) refers to efficiency improvement techniques I)-VI) being incorporated in the model) or omitting the query encoder (VI)—SPLADE-doc) can address the query encoding bottleneck. Further, the results illustrate that sparse retrieval methods with the combined efficiency improvements were not only as efficient as sparse retrieval methods such as BM25, but were also more effective than other sparse retrieval solutions.

There was a trade-off in that at the cost of a slight effectiveness loss (≈1.0 MRR@10 on MS MARCO), the latency of the sparsest SPLADE model was greatly reduced (≈10 fold PISA, ≈2 fold Anserini). For the query encoder choice, BERT-tiny had a slight advantage over SPLADE-doc, which suggests that a query encoder may still be useful in some IR models, even if it is a relatively small one.

IR Evaluation Using Out-of-Domain Data

The above experiments demonstrated improved efficiency and effectiveness of example efficiency-enhanced sparse retrieval methods for in-domain retrieval (e.g., on MS MARCO). Example efficiency-enhanced sparse retrieval methods provided herein are also useful for retrieval of out-of-domain data, as demonstrated in further experiments using the BEIR benchmark.

A subset of the example systems incorporating cumulative efficiency improvements through V) and VI) were compared to the baselines used in Mackenzie et al., 2021, namely BM25, BM25†, DocT5 (Rodrigo Nogueira and Jimmy Lin. 2019. From doc2query to docTTTTTquery), DeepImpact, and UniCOIL-Tilde. The DocT5 method augments passages in the corpus with query predictions generated by the T5 seq2-seq model, and uses BM25 at retrieval time. This method is slower than using BM25 alone, as the document expansion results in larger indexes.

All methods were evaluated on the same machine, and DistilBERT latency was added to UniCOIL-Tilde. Compared to the non-BM25 techniques, example efficiency-enhanced models achieved IR systems that were both more efficient and had better effectiveness for in-domain sparse retrieval. Further, compared to BM25, example efficiency-enhanced models achieved similar efficiency, with a 2× gain on effectiveness.

Additional experiments evaluated the effects on out-of-domain retrieval of example efficiency improvements for sparse retrieval models. SPLADEv2-distil, without the above enumerated enhancements, represents the current single-stage state-of-the-art for out-of-domain retrieval, i.e., on the BIER benchmark.

The out-of-domain experiments tested other methods using BM25 (t refers to queries without stop-words) and DocT5, and SPLADEv2-distil, compared to efficiency-enhanced sparse retrieval methods VI) BT-SPLADE-S, VI) BT-SPLADE-M, and VI) BT-SPLADE-L. BT refers to BERT-tiny query encoder, and VI) refers to efficiency improvement techniques I)-VI) being incorporated in the model.

MS MARCO MRR@10 and BEIR mean nDCG@10 results for each evaluated method are shown in Table 1 below. The SPLADEv2-distil evaluation designated § differed from that of example model SPLADEv2-distil as disclosed in T. Formal et al. due to changes in BEIR.

TABLE 1

| | | | | |
|---|---|---|---|---|
| Method | Latency | MS MARCO | BEIR | BEIR* |

Baselines

| | | | | |
|---|---|---|---|---|
| BM25^{†} | 4 | 19.7 | 44.1 | — |
| DocT5 [29] | 11 | 27.6 | 45.3 | — |
| SPLADEv2-distil [9] | 691 | 36.8 | 49.9^{§} | 51.5 |

Proposed models

| | | | | |
|---|---|---|---|---|
| VI) BT-SPLADE-S | 7 | 35.8 | 41.8 | 46.1 |
| VI) BT-SPLADE-M | 13 | 37.6 | 44.8 | 47.1 |
| VI) BT-SPLADE-L | 32 | 38.0 | 47.1 | 50.1 |

Table 1 shows gains in efficiency and in-domain effectiveness for example efficiency-enhanced retrieval models relative to SPLADEv2-distil inside of the MS MARCO domain, albeit with a reduced performance outside of the MS MARCO domain (BEIR). While the enhanced model still has adequate effectiveness compared to BM25 (unlike most dense models), there were still some losses on certain datasets, including the QUORA dataset, which uses queries (questions) as both documents and queries.

Merging Document Scores with Low-Latency Models

To further improve the effectiveness of out-of-domain retrieval, document scores from example efficiency-enhanced sparse retrieval models can be combined (e.g., merged) with scores obtained by another, e.g., low-latency, method such as BM25 to generate a combined score. Merging the document scores in this way involves a cost, e.g., either adding the latency of the other method (e.g., 4 ms for BM25) to that of the efficiency-enhanced method, or duplicating the computing cost but keeping the latency of the slowest model.

An example merging method uses a simple score combination based in part on Lin et al., In-Batch Negatives for Knowledge Distillation with Tightly-Coupled Teachers for Dense Retrieval. In Proceedings of the 6thWorkshop on Representation Learning for NLP (RepL4NLP-2021). Association for Computational Linguistics, Online, 163-173. doi.org/10.18653/v1/2021.repl4n1p-1.17. In this example method, documents not present in the top (for example) 100 of a model are assigned its smallest score, and then the scores are normalized based on the maximum and minimum document scores of the two methods, assigning equal weight to both. This takes advantage of qualities of both BM25 and SPLADE.

In Table 1, column BEIR* shows results for a document score combination of BM25 and the row's method (SPLADEv2-distil, BT-SPLADE-S, BT-SPLADE-M, and BT-SPLADE-L). The results in Table 1 show that such merging allows the method to outperform SPLADEv2-distil by itself, while running under 40 ms of latency on a single CPU core. For the efficiency-enhanced experimental models (BT-SPLADE-S, BT-SPLADE-M, and BT-SPLADE-L), combining the efficiency enhanced method with BM25 allowed the combination to outperform DocT5 on BEIR with similar latency (11 ms).

The experiments showed that example efficiency enhancing methods can reduce the latency for sparse retrieval models using pretrained LMs. Both efficiency and effectiveness were enhanced for in-domain performance, while the relatively small reduction in out-of-domain performance was mitigated by methods such as merging document scores from the efficiency-enhanced models with those of other sparse retrieval techniques. Example neural sparse retrieval models can achieve similar mono-CPU latency and multi-CPU throughput as a sparse retrieval model such as BM25, while exhibiting similar performance to current state-of-the-art first-stage neural rankers on in-domain data (e.g., MS MARCO) and achieving comparable performance for out-of-domain data (e.g., BEIR) to both BM25 and to most dense first-stage neural rankers.

Network Architecture

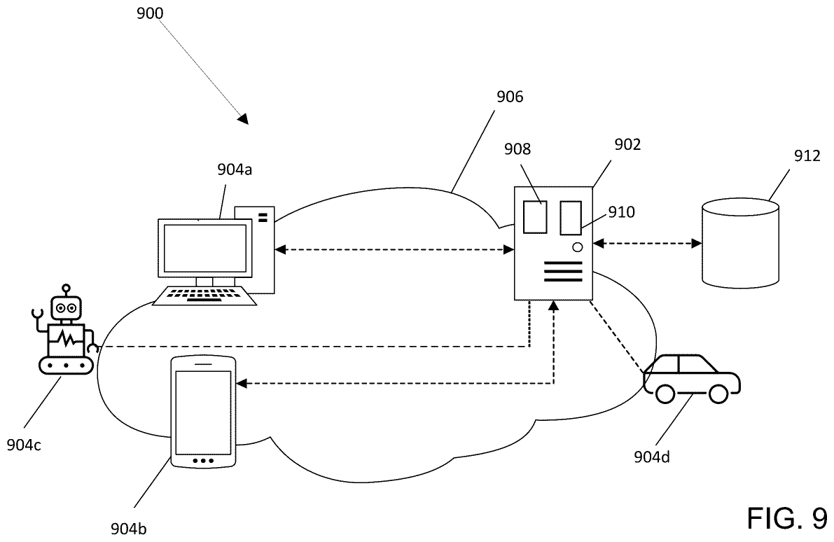

Example systems, methods, and embodiments may be implemented within a network architecture 900 such as illustrated in FIG. 9, which comprises a server 902 and one or more client devices 904 that communicate over a network 906 which may be wireless and/or wired, such as the Internet, for data exchange. The server 902 and the client devices 904a, 904b can each include a processor, e.g., processor 908 and a memory, e.g., memory 910 (shown by example in server 902), such as but not limited to random-access memory (RAM), read-only memory (ROM), hard disks, solid state disks, or other non-volatile storage media. Memory 910 may also be provided in whole or in part by external storage in communication with the processor 908. The server 902, for example, may be embodied in one or more computers. Reference herein to “computer” or “a computer” is intended to refer to one or more computers.

The IR system 100 (shown in FIG. 1) and/or the neural ranker model 104, for instance, may be embodied in the server 902 and/or client devices 904. It will be appreciated that the processor 908 can include either a single processor or multiple processors operating in series or in parallel, and that the memory 910 can include one or more memories, including combinations of memory types and/or locations. Server 902 may also include, but are not limited to, dedicated servers, cloud-based servers, or a combination (e.g., shared). Storage, e.g., a database, may be embodied in suitable storage in the server 902, client device 904, a connected remote storage 912 (shown in connection with the server 902, but can likewise be connected to client devices), or any combination.

Client devices 904 may be any processor-based device, terminal, etc., and/or may be embodied in a client application executable by a processor-based device, etc. Client devices may be disposed within the server 902 and/or external to the server (local or remote, or any combination) and in communication with the server. Example client devices 904 include, but are not limited to, autonomous computers 904a, mobile communication devices (e.g., smartphones, tablet computers, etc.) 904b, robots 904c, autonomous vehicles 904d, wearable devices, virtual reality, augmented reality, or mixed reality devices (not shown), or others. Client devices 904 may be configured for sending data to and/or receiving data from the server 902, and may include, but need not include, one or more output devices, such as but not limited to displays, printers, etc. for displaying or printing results of certain methods that are provided for display by the server. Client devices may include combinations of client devices.

In an example training method, the server 902 or client devices 904 may receive a dataset from any suitable source, e.g., from memory 910 (as nonlimiting examples, internal storage, an internal database, etc.), from external (e.g., remote) storage 912 connected locally or over the network 906. The example training method can generate a trained model that can be likewise stored in the server (e.g., memory 910), client devices 904, external storage 912, or combination. In some example embodiments provided herein, training and/or inference may be performed offline or online (e.g., at run time), in any combination. Results can be output (e.g., displayed, transmitted, provided for display, printed, etc.) and/or stored for retrieving and providing on request.

In an example document processing method the server 902 or client devices 904 may receive one or more documents from any suitable source, e.g., by local or remote input from a suitable interface, or from another of the server or client devices connected locally or over the network 906. Trained models such as the example neural ranking model 104 can be likewise stored in the server (e.g., memory 910), client devices 904, external storage 912, or combination. In some example embodiments provided herein, training and/or inference may be performed offline or online (e.g., at run time), in any combination. Results can be output (e.g., displayed, transmitted, provided for display, printed, etc.) and/or stored for retrieving and providing on request.

In an example retrieval method the server 902 or client devices 904 may receive a query 102 from any suitable source, e.g., by local or remote input from a suitable interface, or from another of the server or client devices connected locally or over the network 906 and process the query using example neural models (or by a more straightforward tokenization, in some example methods). Trained models such as the example neural IR model 100 and/or neural ranker model 104 can be likewise stored in the server (e.g., memory 910), client devices 904, external storage 912, or combination. Results can be output (e.g., displayed, transmitted, provided for display, printed, etc.) and/or stored for retrieving and providing on request.

Generally, embodiments can be implemented as computer program products with a program code or computer-executable instructions, the program code or computer-executable instructions being operative for performing one of the methods when the computer program product runs on a computer. The program code or the computer-executable instructions may, for example, be stored on a computer-readable storage medium.

In an embodiment, a storage medium (or a data carrier, or a computer-readable medium) comprises, stored thereon, the computer program or the computer-executable instructions for performing one of the methods described herein when it is performed by a processor.

Embodiments described herein may be implemented in hardware or in software. The implementation can be performed using a non-transitory storage medium such as a computer-readable storage medium, for example a floppy disc, a DVD, a Blu-Ray, a CD, a ROM, a PROM, and EPROM, an EEPROM or a FLASH memory. Such computer-readable media can be any available media that can be accessed by a general-purpose or special-purpose computer system.

General

Embodiments herein provide, among other things, a computer-implemented ranker fora neural information retrieval model, the ranker comprising: a document encoder comprising a pretrained language model layer, the document encoder being configured to receive one or more documents and generate a sparse representation for each of the documents predicting term importance of the document over a vocabulary; a query encoder configured to receive a query and generate a representation of the query over the vocabulary; a comparator block configured to compare the generated representation of the query to the generated representations of the one or more documents to generate a set of respective document scores and rank the one or more documents based on the generated set of document scores; wherein the document encoder and the query encoder are respectively separate encoders. In addition to any of the above features in this paragraph, the document encoder and the query encoder may be differentiated from one another by one or more of model architecture, model size, model weights, model training, model regularization, model hyperparameters, or model location within the ranker. In addition to any of the above features in this paragraph, the document encoder and the query encoder may be trained using a different regularizer. In addition to any of the above features in this paragraph, the query encoder may be regularized using L1 regularization. In addition to any of the above features in this paragraph, the document encoder may be regularized using FLOPS regularization. In addition to any of the above features in this paragraph, an architecture of the query encoder may be smaller than an architecture of the document encoder. In addition to any of the above features in this paragraph, the document encoder may be configured for document expansion within the vocabulary, with the query encoder not being configured for query expansion within the vocabulary. In addition to any of the above features in this paragraph, the query encoder may be more efficient than the document encoder. In addition to any of the above features in this paragraph, the ranker's efficiency may be gained by reducing how many layers form part of the query encoder. In addition to any of the above features in this paragraph, the ranker's efficiency may be gained by reducing the query encoder to a tokenizer. In addition to any of the above features in this paragraph, the ranker's efficiency may be gained by regularizing query representation. In addition to any of the above features in this paragraph, the query encoder may comprise a pretrained language model that is more efficient than the pretrained language model of the document encoder. In addition to any of the above features in this paragraph, the ranker's efficiency may be gained by using FLOPS regularization during pretraining or middle training. In addition to any of the above features in this paragraph, the document encoder may receive a document as a tokenized input sequence, the tokenized input sequence may be tokenized using the vocabulary; and the pretrained language model layer may be configured to embed each token in the tokenized input sequence with contextual features and to predict an importance with respect to each token of the embedded input sequence over the vocabulary by transforming the context embedded tokens using one or more linear layers. In addition to any of the above features in this paragraph, the document encoder may further comprise: a representation layer configured to receive the predicted importance with respect to each token over the vocabulary and obtain the predicted term importance of the input sequence over the vocabulary, where the representation layer comprises a concave activation layer configured to perform a concave activation of the predicted importance over the embedded input sequence; wherein the representation layer outputs the predicted term importance of the input sequence as the representation of the input sequence over the vocabulary. In addition to any of the above features in this paragraph, the pretrained language model of the document encoder may be trained by middle training before the language model is fine-tuned for information retrieval. In addition to any of the above features in this paragraph, the middle training may occur subsequent to pretraining the pretrained language model for predicting, or the middle training may occur concurrently with pretraining the pretrained language model for predicting to provide enhanced pretraining. In addition to any of the above features in this paragraph, the middle training or enhanced pretraining may comprise training the LM using masked language model (MLM) training combined with FLOPS regularization. In addition to any of the above features in this paragraph, the pretraining and the middle training may include a common MLM loss. In addition to any of the above features in this paragraph, the ranker may be trained using optimization including one or more hyperparameters, and the hyperparameters may be selected based on predetermined query and document sizes. In addition to any of the above features in this paragraph, the ranker may be trained using distillation. In addition to any of the above features in this paragraph, the ranker may be further configured to: produce an additional set of respective document scores for the one or more documents by processing the query using an additional retrieval method having a lower-latency than a method used to generate the set of document scores; merge the set of document scores and the additional set of respective document scores; and rank the one or more documents based on the merged sets of document scores. In addition to any of the above features in this paragraph, the sparse representation for each of the documents predicting term importance of the document over the vocabulary may be a high-dimensional vector with more than half of its elements having a zero-value.

Embodiments may further provide, among other things, a computer-implemented method for information retrieval implemented by a computer having a processor and memory, the method comprising: generating, by a document encoder comprising a pretrained language model layer, a sparse representation for each of one or more received documents predicting term importance of the document over a vocabulary; generating, by a query encoder, a representation of a received query over the vocabulary; comparing the generated representation of the query to the generated representations of the one or more documents to generate a set of respective document scores; and ranking the one or more documents based on the generated set of document scores; wherein the document encoder and the query encoder are respectively separate encoders. In addition to any of the above features in this paragraph, the document encoder and the query encoder may be differentiated from one another by one or more of model architecture, model size, model weights, model training, model regularization, model hyperparameters, or model location within the ranker. In addition to any of the above features in this paragraph, the document encoder and the query encoder may be trained using different regularizers. In addition to any of the above features in this paragraph, the query encoder may be regularized using L1 regularization. In addition to any of the above features in this paragraph, the document encoder may be regularized using FLOPS regularization. In addition to any of the above features in this paragraph, an architecture of the query encoder may be smaller than an architecture of the document encoder. In addition to any of the above features in this paragraph, the document encoder may expand the received one or more documents within the vocabulary, with the query encoder not expanding the received query within the vocabulary. In addition to any of the above features in this paragraph, the query encoder may encode the received query more efficiently than the document encoder encodes each of the received one or more documents. In addition to any of the above features in this paragraph, the query encoder may comprise a pretrained language model that is more efficient than the pretrained language model of the document encoder. In addition to any of the above features in this paragraph, the generating may generate the sparse representation using concave activation functions combined with regularization. In addition to any of the above features in this paragraph, the document encoder may receive each document as a tokenized input sequence, wherein the tokenized input sequence is tokenized using the vocabulary; and the pretrained language model layer may embed each token in the tokenized input sequence with contextual features and to predict an importance with respect to each token of the embedded input sequence over the vocabulary by transforming the context embedded tokens using one or more linear layers. In addition to any of the above features in this paragraph, the document encoder may receive the predicted importance with respect to each token over the vocabulary, obtain the predicted term importance of the input sequence over the vocabulary by performing a concave activation of the predicted importance over the embedded input sequence, and output the predicted term importance of the input sequence as the representation of the input sequence over the vocabulary. In addition to any of the above features in this paragraph, the middle training may occur subsequent to pretraining the pretrained language model for predicting, or the middle training may occur concurrently with pretraining the pretrained language model for predicting to provide enhanced pretraining. In addition to any of the above features in this paragraph, the middle training or enhanced pretraining may comprise training the LM using masked language model (MLM) training combined with FLOPS regularization. In addition to any of the above features in this paragraph, the pretraining and the middle training may include a common MLM loss. In addition to any of the above features in this paragraph, the middle training or the enhanced pretraining may be based on a loss comprising: a standard MLM loss; an MLM loss over a sparse set of logits; and a FLOPS regularization loss. In addition to any of the above features in this paragraph, the ranker may be trained using optimization including one or more hyperparameters; wherein the hyperparameters may be selected based on predetermined query and document sizes. In addition to any of the above features in this paragraph, the ranker may be trained using distillation. In addition to any of the above features in this paragraph, the method may further comprise: producing an additional set of respective document scores for the one or more documents by processing the query using an additional retrieval method having a lower latency than a method used to generate the set of document scores; merging the set of document scores and the additional set of respective document scores; and ranking the one or more documents based on the merged sets of document scores. In addition to any of the above features in this paragraph, the document encoder may generate the sparse representations for at least a subset of the one or more received documents while offline; and the query encoder may generate the representation of the received query while online.

Embodiments may further provide, among other things, a computer-implemented method for information retrieval, the method comprising: generating, by a document encoder comprising a pretrained language model layer, a sparse representation for each of one or more received documents predicting term importance of the document over a vocabulary; generating, by a query encoder, a representation of a received query over the vocabulary; comparing the generated representation of the query to the generated representations of the one or more documents to generate a set of respective document scores; and ranking the one or more documents based on the generated set of document scores; wherein the pretrained language model of the document encoder is trained by middle training before the language model is fine-tuned for information retrieval. In addition to any of the above features in this paragraph, the pretrained language model may be pretrained for predicting. In addition to any of the above features in this paragraph, the middle training may occur subsequent to pretraining the pretrained language model for predicting, or the middle training occurs concurrently with pretraining the pretrained language model for predicting to provide enhanced pretraining. In addition to any of the above features in this paragraph, the query encoder may comprise an additional pretrained language model, and the additional pretrained language model of the query encoder may be trained by middle training or enhanced pretraining before the language model is fine-tuned for information retrieval. In addition to any of the above features in this paragraph, the pretraining and the middle training may use a common MLM loss. In addition to any of the above features in this paragraph, the middle training or enhanced pretraining may comprise training the pretrained LM using masked language model (MLM) training combined with FLOPS regularization. In addition to any of the above features in this paragraph, the middle training or enhanced pretraining may be based on a loss comprising: a standard MLM loss; an MLM loss over a sparse set of logits; and a FLOPS regularization loss. In addition to any of the above features in this paragraph, the document encoder and the query encoder may be respectively separate encoders. In addition to any of the above features in this paragraph, the document encoder and the query encoder may be trained using different regularizers. In addition to any of the above features in this paragraph, the query encoder may be regularized using L1 regularization. In addition to any of the above features in this paragraph, the document encoder may be regularized using FLOPS regularization.

Embodiments may further provide, among other things, a computer-implemented method for training a neural ranker of an information retrieval model implemented by a computer having a processor and memory, the method comprising: initializing parameters of the neural ranker; providing a dataset comprising documents and queries to a document encoder and a query encoder of the ranker, the document encoder comprising a pretrained language model layer and being configured to receive the documents and generate a sparse representation for each of the documents predicting term importance of the document over a vocabulary, the query encoder being separate from the document encoder and configured to receive the queries and generate a representation of the query over the vocabulary; and optimizing a loss including a ranking loss based on the generated representations of the one or more documents and queries and at least one regularization loss; wherein the ranking loss and/or the at least one regularization loss is weighted by a weighting parameter. In addition to any of the above features in this paragraph, the document encoder and the query encoder may be differentiated from one another by one or more of model architecture, model size, model weights, model training, model regularization, model hyperparameters, or model location within the ranker. In addition to any of the above features in this paragraph, the at least one regularization loss may be determined based on different regularizers for the document encoder and the query encoder. In addition to any of the above features in this paragraph, the query encoder may be regularized using L1 regularization. In addition to any of the above features in this paragraph, the document encoder may be regularized using FLOPS regularization. In addition to any of the above features in this paragraph, the query encoder may comprise a pretrained language model that is more efficient than the pretrained language model of the document encoder. In addition to any of the above features in this paragraph, the method may further comprise: middle training or enhanced pretraining the pretrained language model of the document encoder before the language model is fine-tuned for information retrieval. In addition to any of the above features in this paragraph, the middle training occurs subsequent to pretraining the language model, or concurrent with pretraining the language model to provide the enhanced pretraining. In addition to any of the above features in this paragraph, the pretrained language model may be pretrained for predicting; and the middle training or enhanced pretraining may comprise training the LM using masked language model (MLM) training combined with FLOPS regularization. In addition to any of the above features in this paragraph, the pretraining and the middle training may use a common MLM loss. In addition to any of the above features in this paragraph, the middle training may be based on a loss comprising: a standard MLM loss; an MLM loss over a sparse set of logits; and a FLOPS regularization loss. In addition to any of the above features in this paragraph, the ranker may be trained using optimization including one or more hyperparameters; and the hyperparameters may be selected based on predetermined query and document sizes. In addition to any of the above features in this paragraph, the ranker may be trained using distillation.

Embodiments may further provide, among other things, a non-transitory computer-readable medium having executable instructions stored thereon for causing a processor and a memory to implement a method for neural information retrieval comprising: generating, by a document encoder comprising a pretrained language model layer, a sparse representation for each of one or more received documents predicting term importance of the document over a vocabulary; generating, by a query encoder, a representation of a received query over the vocabulary; comparing the generated representation of the query to the generated representations of the one or more documents to generate a set of respective document scores; and ranking the one or more documents based on the generated set of document scores; wherein the document encoder and the query encoder are respectively separate encoders. In addition to any of the above features in this paragraph, the document encoder and the query encoder may be differentiated from one another by one or more of model architecture, model size, model weights, model training, model regularization, model hyperparameters, or model location within the ranker.

Embodiments may further provide, among other things, a computer-implemented method for training an encoder implemented by a computer having a processor and memory, the method comprising: middle training a pretrained language model of the encoder; and fine-tuning the pretrained language model of the encoder for information retrieval after said middle training; wherein the encoder after said fine-tuning is configured for generating a sparse representation for each of one or more received documents predicting term importance of the document over a vocabulary. In addition to any of the above features in this paragraph, the method may further comprise: pretraining the language model of the encoder, wherein said middle training occurs subsequent to or concurrent with said pretraining. In addition to any of the above features in this paragraph, the middle training may comprise training the LM using masked language model (MLM) training combined with FLOPS regularization In addition to any of the above features in this paragraph, the pretrained language model of the encoder may be pretrained for predicting. In addition to any of the above features in this paragraph, the middle training may use a common MLM loss to an MLM loss used to pretrain the pretrained language model. In addition to any of the above features in this paragraph, the method may further comprise pretraining a language model of the encoder to provide the pretrained language model of the encoder, wherein the pretraining and the middle training use a common MLM loss. In addition to any of the above features in this paragraph, the middle training may comprise training the LM using masked language model (MLM) training combined with FLOPS regularization. In addition to any of the above features in this paragraph, the middle training may be based on a loss comprising: a standard MLM loss; an MLM loss over a sparse set of logits; and a FLOPS regularization loss. In addition to any of the above features in this paragraph, the pretrained language model layer after fine-tuning may be configured to embed each token in a tokenized input sequence for the document with contextual features and to predict an importance with respect to each token of the embedded input sequence over the vocabulary by transforming the context embedded tokens using one or more linear layers. In addition to any of the above features in this paragraph, the encoder may further comprise a representation layer configured to receive the predicted importance with respect to each token over the vocabulary and obtain the predicted term importance of the input sequence over the vocabulary, where the representation layer may comprise a concave activation layer configured to perform a concave activation of the predicted importance over the embedded input sequence; and where the representation layer may output the predicted term importance of the input sequence as the representation of the input sequence over the vocabulary. In addition to any of the above features in this paragraph, the encoder may comprise a document encoder. In addition to any of the above features in this paragraph, the document encoder may be incorporated into a ranker for information retrieval. In addition to any of the above features in this paragraph, the encoder may comprise a query encoder. In addition to any of the above features in this paragraph, the query encoder may be incorporated into a ranker for information retrieval.

Embodiments may further provide, among other things, an encoder trained according to any of the methods disclosed herein. Embodiments may further provide, among other things, a ranker for information retrieval may comprise an encoder according to this paragraph,

The foregoing description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure may be implemented in and/or combined with features of any of the other embodiments, even if that combination is not explicitly described. In other words, the described embodiments are not mutually exclusive, and permutations of one or more embodiments with one another remain within the scope of this disclosure. All documents cited herein are hereby incorporated by reference in their entirety, without an admission that any of these documents constitute prior art.

Each module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module. Each module may be implemented using code. The term code, as used above, may include software, firmware, and/or microcode, and may refer to programs, routines, functions, classes, data structures, and/or objects.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The systems and methods described in this application may be partially or fully implemented by a special purpose computer created by configuring a general-purpose computer to execute one or more particular functions embodied in computer programs. The functional blocks, flowchart components, and other elements described above serve as software specifications, which may be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

It will be appreciated that variations of the above-disclosed embodiments and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above and the following claims.

1. A computer-implemented ranker fora neural information retrieval model, the ranker comprising:
a document encoder comprising a pretrained language model layer, the document encoder being configured to receive one or more documents and generate a sparse representation for each of the documents predicting term importance of the document over a vocabulary;
a query encoder configured to receive a query and generate a representation of the query over the vocabulary;
a comparator block configured to compare the generated representation of the query to the generated representations of the one or more documents to generate a set of respective document scores and rank the one or more documents based on the generated set of document scores;
wherein the document encoder and the query encoder are respectively separate encoders.

2. The ranker of claim 1, wherein the document encoder and the query encoder are differentiated from one another by one or more of model architecture, model size, model weights, model training, model regularization, model hyperparameters, or model location within the ranker.

3. The ranker of claim 1, wherein the document encoder and the query encoder are trained using a different regularizer; and
wherein the query encoder is regularized using L1 regularization, and the document encoder is regularized using FLOPS regularization.

4. The ranker of claim 1, wherein an architecture of the query encoder is smaller than an architecture of the document encoder; and
wherein the document encoder is configured for document expansion within the vocabulary, and the query encoder is not configured for query expansion within the vocabulary.

5. The ranker of claim 1, wherein the query encoder is more efficient than the document encoder; and
wherein efficiency is gained by one of (i) reducing how many layers form part of the query encoder, (ii) reducing the query encoder to a tokenizer, and (iii) regularizing query representation.

6. The ranker of claim 1, wherein the query encoder comprises a pretrained language model that is more efficient than the pretrained language model of the document encoder; and
wherein the efficiency is gained by using FLOPS regularization during pretraining or middle training.

7. The ranker of claim 1,
wherein the document encoder receives a document as a tokenized input sequence, wherein the tokenized input sequence is tokenized using the vocabulary;
wherein the pretrained language model layer is configured to embed each token in the tokenized input sequence with contextual features and to predict an importance with respect to each token of the embedded input sequence over the vocabulary by transforming the context embedded tokens using one or more linear layers; and
wherein the document encoder further comprises:
a representation layer configured to receive the predicted importance with respect to each token over the vocabulary and obtain the predicted term importance of the input sequence over the vocabulary, said representation layer comprising a concave activation layer configured to perform a concave activation of the predicted importance over the embedded input sequence;
wherein the representation layer outputs the predicted term importance of the input sequence as the representation of the input sequence over the vocabulary.

8. The ranker of claim 1, wherein the pretrained language model of the document encoder is trained by middle training before the language model is fine-tuned for information retrieval;
wherein the middle training occurs subsequent to pretraining the pretrained language model for predicting, or the middle training occurs concurrently with pretraining the pretrained language model for predicting to provide enhanced pretraining; and
wherein the middle training or enhanced pretraining comprises training the LM using masked language model (MLM) training combined with FLOPS regularization.

9. The ranker of claim 1, wherein the ranker is trained using optimization including one or more hyperparameters;
wherein the hyperparameters are selected based on predetermined query and document sizes; and
wherein the ranker is trained using distillation.

10. The ranker of claim 1,
wherein the ranker is further configured to:
produce an additional set of respective document scores for the one or more documents by processing the query using an additional retrieval method having a lower-latency than a method used to generate the set of document scores;
merge the set of document scores and the additional set of respective document scores; and
rank the one or more documents based on the merged sets of document scores.

11. The ranker of claim 1, wherein the sparse representation for each of the documents predicting term importance of the document over the vocabulary is a high-dimensional vector with more than half of its elements having a zero-value.

12. A computer-implemented method for information retrieval, the method comprising:
generating, by a document encoder comprising a pretrained language model layer, a sparse representation for each of one or more received documents predicting term importance of the document over a vocabulary;
generating, by a query encoder, a representation of a received query over the vocabulary;
comparing the generated representation of the query to the generated representations of the one or more documents to generate a set of respective document scores; and
ranking the one or more documents based on the generated set of document scores;
wherein the document encoder and the query encoder are respectively separate encoders.

13. The method of claim 12, wherein the document encoder and the query encoder are differentiated from one another by one or more of model architecture, model size, model weights, model training, model regularization, model hyperparameters, or model location within the ranker.

14. The method of claim 12, wherein the document encoder and the query encoder are trained using different regularizers, the query encoder is regularized using L1 regularization, and the document encoder is regularized using FLOPS regularization.

15. The method of claim 12, wherein an architecture of the query encoder is smaller than an architecture of the document encoder.

16. The method of claim 12, wherein the document encoder expands the received one or more documents within the vocabulary, and the query encoder does not expand the received query within the vocabulary.

17. The method of claim 12, wherein said generating generates the sparse representation using concave activation functions combined with regularization.

18. The method of claim 12,
wherein the document encoder receives each document as a tokenized input sequence, wherein the tokenized input sequence is tokenized using the vocabulary;
wherein the pretrained language model layer embeds each token in the tokenized input sequence with contextual features and to predict an importance with respect to each token of the embedded input sequence over the vocabulary by transforming the context embedded tokens using one or more linear layers.

19. The method of claim 18,
wherein the document encoder receives the predicted importance with respect to each token over the vocabulary, obtains the predicted term importance of the input sequence over the vocabulary by performing a concave activation of the predicted importance over the embedded input sequence, and outputs the predicted term importance of the input sequence as the representation of the input sequence over the vocabulary.

20. The method of claim 12, wherein the pretrained language model of the document encoder is trained by middle training before the language model is fine-tuned for information retrieval;
wherein the middle training occurs subsequent to pretraining the pretrained language model for predicting, or the middle training occurs concurrently with pretraining the pretrained language model for predicting to provide enhanced pretraining.

21. The method of claim 20, wherein the pretrained language model is pretrained for predicting; and
wherein the middle training or enhanced pretraining comprises training the pretrained LM using masked language model (MLM) training combined with FLOPS regularization.

22. The method of claim 21, wherein the middle training or enhanced pretraining is based on a loss comprising:
a standard MLM loss;
an MLM loss over a sparse set of logits; and
a FLOPS regularization loss.

23. The method of claim 12, wherein the ranker is trained using optimization including one or more hyperparameters;
wherein the hyperparameters are selected based on predetermined query and document sizes.

24. The method of claim 12,
wherein the ranker is trained using distillation.

25. The method of claim 12, further comprising:
producing an additional set of respective document scores for the one or more documents by processing the query using an additional retrieval method having a lower latency than a method used to generate the set of document scores;
merging the set of document scores and the additional set of respective document scores; and
ranking the one or more documents based on the merged sets of document scores.

26. The method of claim 12, wherein the document encoder generates the sparse representations for at least a subset of the one or more received documents while offline; and
wherein the query encoder generates the representation of the received query while online.

27. A computer-implemented method for information retrieval, the method comprising:
generating, by a document encoder comprising a pretrained language model layer, a sparse representation for each of one or more received documents predicting term importance of the document over a vocabulary;
generating, by a query encoder, a representation of a received query over the vocabulary;
comparing the generated representation of the query to the generated representations of the one or more documents to generate a set of respective document scores; and
ranking the one or more documents based on the generated set of document scores;
wherein the pretrained language model of the document encoder is trained by middle training before the language model is fine-tuned for information retrieval.

28. The method of claim 27, wherein the pretrained language model is pretrained for predicting;
wherein the middle training occurs subsequent to pretraining the pretrained language model for predicting, or the middle training occurs concurrently with pretraining the pretrained language model for predicting to provide enhanced pretraining.

29. The method of claim 27, wherein the query encoder comprises an additional pretrained language model, and where the additional pretrained language model of the query encoder is trained by middle training or enhanced pretraining before the language model is fine-tuned for information retrieval.

30. The method of claim 27, wherein the middle training or enhanced pretraining is based on a loss comprising:
a standard MLM loss;
an MLM loss over a sparse set of logits; and
a FLOPS regularization loss.

31. The method of claim 27, wherein the middle training or enhanced pretraining comprises training the pretrained LM using masked language model (MLM) training combined with FLOPS regularization.

32. The method of claim 27, wherein the document encoder and the query encoder are respectively separate encoders.

33. The method of claim 32, wherein the document encoder and the query encoder are trained using different regularizers; and wherein the query encoder is regularized using L1 regularization, and the document encoder is regularized using FLOPS regularization.

34. A computer-implemented method for training a neural ranker of an information retrieval model, the method comprising:
initializing parameters of the neural ranker;
providing a dataset comprising documents and queries to a document encoder and a query encoder of the ranker, the document encoder comprising a pretrained language model layer and being configured to receive the documents and generate a sparse representation for each of the documents predicting term importance of the document over a vocabulary, the query encoder being separate from the document encoder and configured to receive the queries and generate a representation of the query over the vocabulary; and
optimizing a loss including a ranking loss based on the generated representations of the one or more documents and queries and at least one regularization loss;
wherein the ranking loss and/or the at least one regularization loss is weighted by a weighting parameter.

35. The method of claim 34, wherein the document encoder and the query encoder are differentiated from one another by one or more of model architecture, model size, model weights, model training, model regularization, model hyperparameters, or model location within the ranker.

36. The method of claim 34, wherein the at least one regularization loss is determined based on different regularizers for the document encoder and the query encoder;
wherein the query encoder is regularized using L1 regularization, and the document encoder is regularized using FLOPS regularization; and
wherein the query encoder comprises a pretrained language model that is more efficient than the pretrained language model of the document encoder.

37. The method of claim 34, further comprising:
middle training or enhanced pretraining the pretrained language model of the document encoder before the language model is fine-tuned for information retrieval.

38. The method of claim 34, wherein the pretrained language model is pretrained for predicting;
wherein the middle training comprises training the LM using masked language model (MLM) training combined with FLOPS regularization; and
wherein the pretraining and the middle training use a common MLM loss.

39. The method of claim 34, wherein the ranker is trained using optimization including one or more hyperparameters;
wherein the hyperparameters are selected based on predetermined query and document sizes.

40. The method of claim 34,
wherein the ranker is trained using distillation.

41. A computer-implemented method for training an encoder, the method comprising:
middle training a pretrained language model of the encoder; and
fine-tuning the pretrained language model of the encoder for information retrieval after said middle training;
wherein the encoder after said fine-tuning is configured for generating a sparse representation for each of one or more received documents predicting term importance of the document over a vocabulary.

42. The method of claim 41, further comprising:
pretraining the language model of the encoder, wherein said middle training occurs subsequent to or concurrent with said pretraining;
wherein the pretrained language model of the encoder is pretrained for predicting; and
wherein the middle training comprises training the LM using masked language model (MLM) training combined with FLOPS regularization.

43. The method of claim 42, wherein the pretrained language model layer after fine-tuning is configured to embed each token in a tokenized input sequence for the document with contextual features and to predict an importance with respect to each token of the embedded input sequence over the vocabulary by transforming the context embedded tokens using one or more linear layers.

44. The method of claim 43, wherein the encoder further comprises a representation layer configured to receive the predicted importance with respect to each token over the vocabulary and obtain the predicted term importance of the input sequence over the vocabulary, the representation layer comprising a concave activation layer configured to perform a concave activation of the predicted importance over the embedded input sequence;
wherein the representation layer outputs the predicted term importance of the input sequence as the representation of the input sequence over the vocabulary.

45. The method of claim 44, wherein the encoder comprises a document encoder, and the document encoder is incorporated into a ranker for information retrieval.

46. The method of claim 44, wherein the encoder comprises a query encoder, and the query encoder is incorporated into a ranker for information retrieval.
